(19) United States
(12) Patent Application Publication
(10) Pub. No.: US 2026/0222677 A1
(43) Pub. Date: Jul. 30, 2026

(54) DYNAMIC REAR-DISPLAY FEEDBACK

(71) Applicant: Apple Inc., Cupertino, CA (US)

(72) Inventors: Robert B. CHUN, La Mesa, CA (US); Edward AMINOV, San Diego, CA (US); Brian C. FATA, San Diego, CA (US); Soumya JINDAL, San Jose, CA (US); Dana F. SEGLER, Jr., Gilroy, CA (US)

(21) Appl. No.: 19/569,517

(22) Filed: Mar. 17, 2026

Related U.S. Application Data
(63) Continuation of application No. PCT/US2024/048985, filed on Sep. 27, 2024.
(60) Provisional application No. 63/621,522, filed on Jan. 16, 2024.
(60) Provisional application No. 63/541,550, filed on Sep. 29, 2023.

(51) Int. Cl. H04N 23/63; H04N 23/667

(52) U.S. Cl. CPC H04N 23/635; H04N 23/632; H04N 23/667

(57) ABSTRACT

The present disclosure generally relates to user interfaces and techniques displaying content using a rear-side display of a computer system. In some embodiments, camera feedback is provided using a rear-side display. In some embodiments, contextual display of a digital decoration is provided using a rear-side display. In some embodiments, status information is provided using a rear-side display based on a use context of the computer system. In some embodiments, language translation is provided using a rear-side display.

### CROSS-REFERENCE TO RELATED APPLICATIONS

This application is a continuation of PCT Patent Application Serial No. PCT/US2024/048985, entitled “DYNAMIC REAR-DISPLAY FEEDBACK,” filed September 27, 2024, which claims priority to U.S. Provisional Patent Application No. 63/621,522, entitled “DYNAMIC REAR-DISPLAY FEEDBACK,” filed January 16, 2024, and to U.S. Provisional Patent Application No. 63/541,550, entitled “DYNAMIC REAR-DISPLAY FEEDBACK,” filed September 29, 2023. The contents of each of these applications are incorporated herein by reference in their entirety.

### FIELD

The present disclosure relates generally to techniques for displaying content using a rear-side display.

### DESCRIPTION OF RELATED ART

Electronic devices can include display components for displaying content for interacting with the electronic device.

### BRIEF SUMMARY

Example methods are described herein. An example method includes, at a computer system that is in communication with one or more cameras and two or more display generation components including a first display generation component that is located on a first side of the computer system and a second display generation component that is different from the first display generation component and is located on a second side of the computer system that is different from the first side of the computer system, wherein the second display generation component is configured to display content at a lower fidelity than the first display generation component: capturing data using the one or more cameras; and while capturing data using the one or more cameras, displaying, via the second display generation component, camera status information that indicates a status for the one or more cameras.

An example method includes, at a computer system that is connected to a housing that surrounds at least a portion of the computer system: detecting a respective triggering event; and in response to detecting the respective triggering event: in accordance with a determination that the respective triggering event meets criteria for being a first triggering event, causing the housing to have a first appearance; and in accordance with a determination that the respective triggering event meets criteria for being a second triggering event that is different from the first triggering event, causing the housing to have a second appearance that is different from the first appearance.

An example method includes, at a computer system that is connected to a first display generation component and a second display generation component that is different from the first display generation component: detecting occurrence of an event; and in response to detecting occurrence of the event: in accordance with a determination that the computer system is in a first use context, displaying, via the second display generation component, information about the event on a surface of the computer system that is separate from the first display generation component; and in accordance with a determination that the computer system is not in the first use context, forgoing displaying the information about the event on the surface of the computer system that is separate from the first display generation component.

An example method includes, at a computer system that is in communication with one or more input devices and two or more display generation components including a first display generation component that is located on a first side of the computer system and a second display generation component that is different from the first display generation component and is located on a second side of the computer system that is different from the first side of the computer system: while the computer system is operating in a respective mode for providing language translation: detecting, via the one or more input devices, a first word-based input; and in response to detecting the first word-based input: displaying, via the first display generation component that is located on the first side of the computer system, a first representation of the first word-based input, wherein the first representation of the first word-based input is displayed in a first language; and displaying, via the second display generation component that is located on the second side of the computer system, a second representation of the first word-based input, wherein the second representation of the first word-based input is a translation of the first word-based input that displayed in a second language that is different from the first language.

Example non-transitory computer-readable storage media are described herein. An example non-transitory computer-readable storage medium stores one or more programs configured to be executed by one or more processors of a computer system that is in communication with one or more cameras and two or more display generation components including a first display generation component that is located on a first side of the computer system and a second display generation component that is different from the first display generation component and is located on a second side of the computer system that is different from the first side of the computer system, wherein the second display generation component is configured to display content at a lower fidelity than the first display generation component, the one or more programs including instructions for: capturing data using the one or more cameras; and while capturing data using the one or more cameras, displaying, via the second display generation component, camera status information that indicates a status for the one or more cameras.

An example non-transitory computer-readable storage medium stores one or more programs configured to be executed by one or more processors of a computer system that is connected to a housing that surrounds at least a portion of the computer system, the one or more programs including instructions for: detecting a respective triggering event; and in response to detecting the respective triggering event: in accordance with a determination that the respective triggering event meets criteria for being a first triggering event, causing the housing to have a first appearance; and in accordance with a determination that the respective triggering event meets criteria for being a second triggering event that is different from the first triggering event, causing the housing to have a second appearance that is different from the first appearance.

An example non-transitory computer-readable storage medium stores one or more programs configured to be executed by one or more processors of a computer system that is connected to a first display generation component and a second display generation component that is different from the first display generation component, the one or more programs including instructions for: detecting occurrence of an event; and in response to detecting occurrence of the event: in accordance with a determination that the computer system is in a first use context, displaying, via the second display generation component, information about the event on a surface of the computer system that is separate from the first display generation component; and in accordance with a determination that the computer system is not in the first use context, forgoing displaying the information about the event on the surface of the computer system that is separate from the first display generation component.

An example non-transitory computer-readable storage medium stores one or more programs configured to be executed by one or more processors of a computer system that is in communication with one or more input devices and two or more display generation components including a first display generation component that is located on a first side of the computer system and a second display generation component that is different from the first display generation component and is located on a second side of the computer system that is different from the first side of the computer system, the one or more programs including instructions for: while the computer system is operating in a respective mode for providing language translation: detecting, via the one or more input devices, a first word-based input; and in response to detecting the first word-based input: displaying, via the first display generation component that is located on the first side of the computer system, a first representation of the first word-based input, wherein the first representation of the first word-based input is displayed in a first language; and displaying, via the second display generation component that is located on the second side of the computer system, a second representation of the first word-based input, wherein the second representation of the first word-based input is a translation of the first word-based input that displayed in a second language that is different from the first language.

Example transitory computer-readable storage media are described herein. An example transitory computer-readable storage medium stores one or more programs configured to be executed by one or more processors of a computer system that is in communication with one or more cameras and two or more display generation components including a first display generation component that is located on a first side of the computer system and a second display generation component that is different from the first display generation component and is located on a second side of the computer system that is different from the first side of the computer system, wherein the second display generation component is configured to display content at a lower fidelity than the first display generation component, the one or more programs including instructions for: capturing data using the one or more cameras; and while capturing data using the one or more cameras, displaying, via the second display generation component, camera status information that indicates a status for the one or more cameras.

An example transitory computer-readable storage medium stores one or more programs configured to be executed by one or more processors of a computer system that is connected to a housing that surrounds at least a portion of the computer system, the one or more programs including instructions for: detecting a respective triggering event; and in response to detecting the respective triggering event: in accordance with a determination that the respective triggering event meets criteria for being a first triggering event, causing the housing to have a first appearance; and in accordance with a determination that the respective triggering event meets criteria for being a second triggering event that is different from the first triggering event, causing the housing to have a second appearance that is different from the first appearance.

An example transitory computer-readable storage medium stores one or more programs configured to be executed by one or more processors of a computer system that is connected to a first display generation component and a second display generation component that is different from the first display generation component, the one or more programs including instructions for: detecting occurrence of an event; and in response to detecting occurrence of the event: in accordance with a determination that the computer system is in a first use context, displaying, via the second display generation component, information about the event on a surface of the computer system that is separate from the first display generation component; and in accordance with a determination that the computer system is not in the first use context, forgoing displaying the information about the event on the surface of the computer system that is separate from the first display generation component.

An example transitory computer-readable storage medium stores one or more programs configured to be executed by one or more processors of a computer system that is in communication with one or more input devices and two or more display generation components including a first display generation component that is located on a first side of the computer system and a second display generation component that is different from the first display generation component and is located on a second side of the computer system that is different from the first side of the computer system, the one or more programs including instructions for: while the computer system is operating in a respective mode for providing language translation: detecting, via the one or more input devices, a first word-based input; and in response to detecting the first word-based input: displaying, via the first display generation component that is located on the first side of the computer system, a first representation of the first word-based input, wherein the first representation of the first word-based input is displayed in a first language; and displaying, via the second display generation component that is located on the second side of the computer system, a second representation of the first word-based input, wherein the second representation of the first word-based input is a translation of the first word-based input that displayed in a second language that is different from the first language.

Example computer systems are described herein. An example computer system is in communication with one or more cameras and two or more display generation components including a first display generation component that is located on a first side of the computer system and a second display generation component that is different from the first display generation component and is located on a second side of the computer system that is different from the first side of the computer system, wherein the second display generation component is configured to display content at a lower fidelity than the first display generation component, comprising: one or more processors; and memory storing one or more programs configured to be executed by the one or more processors, the one or more programs including instructions for: capturing data using the one or more cameras; and while capturing data using the one or more cameras, displaying, via the second display generation component, camera status information that indicates a status for the one or more cameras.

An example computer system is connected to a housing that surrounds at least a portion of the computer system, and comprises: one or more processors; and memory storing one or more programs configured to be executed by the one or more processors, the one or more programs including instructions for: detecting a respective triggering event; and in response to detecting the respective triggering event: in accordance with a determination that the respective triggering event meets criteria for being a first triggering event, causing the housing to have a first appearance; and in accordance with a determination that the respective triggering event meets criteria for being a second triggering event that is different from the first triggering event, causing the housing to have a second appearance that is different from the first appearance.

An example computer system is connected to a first display generation component and a second display generation component that is different from the first display generation component, and comprises: one or more processors; and memory storing one or more programs configured to be executed by the one or more processors, the one or more programs including instructions for: detecting occurrence of an event; and in response to detecting occurrence of the event: in accordance with a determination that the computer system is in a first use context, displaying, via the second display generation component, information about the event on a surface of the computer system that is separate from the first display generation component; and in accordance with a determination that the computer system is not in the first use context, forgoing displaying the information about the event on the surface of the computer system that is separate from the first display generation component.

An example computer system is in communication with one or more input devices and two or more display generation components including a first display generation component that is located on a first side of the computer system and a second display generation component that is different from the first display generation component and is located on a second side of the computer system that is different from the first side of the computer system, and comprises: one or more processors; and memory storing one or more programs configured to be executed by the one or more processors, the one or more programs including instructions for: while the computer system is operating in a respective mode for providing language translation: detecting, via the one or more input devices, a first word-based input; and in response to detecting the first word-based input: displaying, via the first display generation component that is located on the first side of the computer system, a first representation of the first word-based input, wherein the first representation of the first word-based input is displayed in a first language; and displaying, via the second display generation component that is located on the second side of the computer system, a second representation of the first word-based input, wherein the second representation of the first word-based input is a translation of the first word-based input that displayed in a second language that is different from the first language.

An example computer system is configured to communicate with one or more cameras and two or more display generation components including a first display generation component that is located on a first side of the computer system and a second display generation component that is different from the first display generation component and is located on a second side of the computer system that is different from the first side of the computer system, wherein the second display generation component is configured to display content at a lower fidelity than the first display generation component, and includes: means for capturing data using the one or more cameras; and means for, while capturing data using the one or more cameras, displaying, via the second display generation component, camera status information that indicates a status for the one or more cameras.

An example computer system is connected to a housing that surrounds at least a portion of the computer system and includes means for detecting a respective triggering event; and means for, in response to detecting the respective triggering event: in accordance with a determination that the respective triggering event meets criteria for being a first triggering event, causing the housing to have a first appearance; and in accordance with a determination that the respective triggering event meets criteria for being a second triggering event that is different from the first triggering event, causing the housing to have a second appearance that is different from the first appearance.

An example computer system is connected to a first display generation component and a second display generation component that is different from the first display generation component, and includes: means for detecting occurrence of an event; and means for, in response to detecting occurrence of the event: in accordance with a determination that the computer system is in a first use context, displaying, via the second display generation component, information about the event on a surface of the computer system that is separate from the first display generation component; and in accordance with a determination that the computer system is not in the first use context, forgoing displaying the information about the event on the surface of the computer system that is separate from the first display generation component.

An example computer system is in communication with one or more input devices and two or more display generation components including a first display generation component that is located on a first side of the computer system and a second display generation component that is different from the first display generation component and is located on a second side of the computer system that is different from the first side of the computer system, and includes means for, while the computer system is operating in a respective mode for providing language translation: detecting, via the one or more input devices, a first word-based input; and in response to detecting the first word-based input: displaying, via the first display generation component that is located on the first side of the computer system, a first representation of the first word-based input, wherein the first representation of the first word-based input is displayed in a first language; and displaying, via the second display generation component that is located on the second side of the computer system, a second representation of the first word-based input, wherein the second representation of the first word-based input is a translation of the first word-based input that displayed in a second language that is different from the first language.

Example computer program products are described herein. An example computer program product includes one or more programs configured to be executed by one or more processors of a computer system that is in communication with one or more cameras and two or more display generation components including a first display generation component that is located on a first side of the computer system and a second display generation component that is different from the first display generation component and is located on a second side of the computer system that is different from the first side of the computer system, wherein the second display generation component is configured to display content at a lower fidelity than the first display generation component, the one or more programs including instructions for: capturing data using the one or more cameras; and while capturing data using the one or more cameras, displaying, via the second display generation component, camera status information that indicates a status for the one or more cameras.

An example computer program product includes one or more programs configured to be executed by one or more processors of a computer system that is connected to a housing that surrounds at least a portion of the computer system, the one or more programs including instructions for: detecting a respective triggering event; and in response to detecting the respective triggering event: in accordance with a determination that the respective triggering event meets criteria for being a first triggering event, causing the housing to have a first appearance; and in accordance with a determination that the respective triggering event meets criteria for being a second triggering event that is different from the first triggering event, causing the housing to have a second appearance that is different from the first appearance.

An example computer program product includes one or more programs configured to be executed by one or more processors of a computer system that is connected to a first display generation component and a second display generation component that is different from the first display generation component, the one or more programs including instructions for: detecting occurrence of an event; and in response to detecting occurrence of the event: in accordance with a determination that the computer system is in a first use context, displaying, via the second display generation component, information about the event on a surface of the computer system that is separate from the first display generation component; and in accordance with a determination that the computer system is not in the first use context, forgoing displaying the information about the event on the surface of the computer system that is separate from the first display generation component.

An example computer program product includes one or more programs configured to be executed by one or more processors of a computer system that is in communication with one or more input devices and two or more display generation components including a first display generation component that is located on a first side of the computer system and a second display generation component that is different from the first display generation component and is located on a second side of the computer system that is different from the first side of the computer system, the one or more programs including instructions for: while the computer system is operating in a respective mode for providing language translation: detecting, via the one or more input devices, a first word-based input; and in response to detecting the first word-based input: displaying, via the first display generation component that is located on the first side of the computer system, a first representation of the first word-based input, wherein the first representation of the first word-based input is displayed in a first language; and displaying, via the second display generation component that is located on the second side of the computer system, a second representation of the first word-based input, wherein the second representation of the first word-based input is a translation of the first word-based input that displayed in a second language that is different from the first language.

In some embodiments, executable instructions for performing these functions are included in a non-transitory computer-readable storage medium or other computer program product configured for execution by one or more processors. In some embodiments, executable instructions for performing these functions are included in a transitory computer-readable storage medium or other computer program product configured for execution by one or more processors.

### BRIEF DESCRIPTION OF THE FIGURES

To better understand the various described embodiments, reference should be made to the Description of Embodiments below, along with the following drawings in which like reference numerals refer to corresponding parts throughout the figures.

FIG. 1 illustrates an example system for implementing the techniques described herein.

FIGS. 2A-2I illustrate exemplary user interfaces for providing camera feedback using a rear-side display, in accordance with some embodiments.

FIG. 3 is a flow diagram illustrating a method for providing camera feedback using a rear-side display, in accordance with some embodiments.

FIGS. 4A-4M illustrate exemplary user interfaces for providing contextual display of a digital decoration using a rear-side display, in accordance with some embodiments.

FIG. 5 is a flow diagram illustrating a method for providing contextual display of a digital decoration using a rear-side display, in accordance with some embodiments.

FIGS. 6A-6F illustrate exemplary user interfaces for providing status information using a rear-side display based on a use context of an electronic device, in accordance with some embodiments.

FIG. 7 is a flow diagram illustrating a method for providing status information using a rear-side display based on a use context of an electronic device, in accordance with some embodiments.

FIGS. 8A-8E illustrate exemplary user interfaces for providing language translation using a rear-side display, in accordance with some embodiments.

FIG. 9 is a flow diagram illustrating a method for providing language translation using a rear-side display, in accordance with some embodiments.

### DESCRIPTION OF EMBODIMENTS

The following description sets forth exemplary methods, parameters, and the like. However, such description is not intended as a limitation on the scope of the present disclosure but is instead provided as a description of exemplary embodiments.

Although the following description uses terms “first,” “second,” etc. to describe various elements, these elements should not be limited by the terms. In some embodiments, these terms are used to distinguish one element from another. For example, a first item could be termed a second item, and, similarly, a second item could be termed a first item, without departing from the scope of the various described embodiments. In some embodiments, the first item and the second item are two separate references to the same item. In some embodiments, the first item and the second item are both the same type of item, but they are not the same item.

The terminology used in the description of the various described embodiments herein is for the purpose of describing particular embodiments only and is not intended to be limiting. The singular forms “a,” “an,” and “the” are intended to include the plural forms as well, unless the context clearly indicates otherwise. The term “and/or” refers to and encompasses any and all possible combinations of one or more of the associated listed items. The terms “includes,” “including,” “comprises,” and/or “comprising” specify the presence of stated features, steps, operations, elements, and/or components, but do not preclude the presence or addition of one or more other features, steps, operations, elements, components, and/or groups thereof.

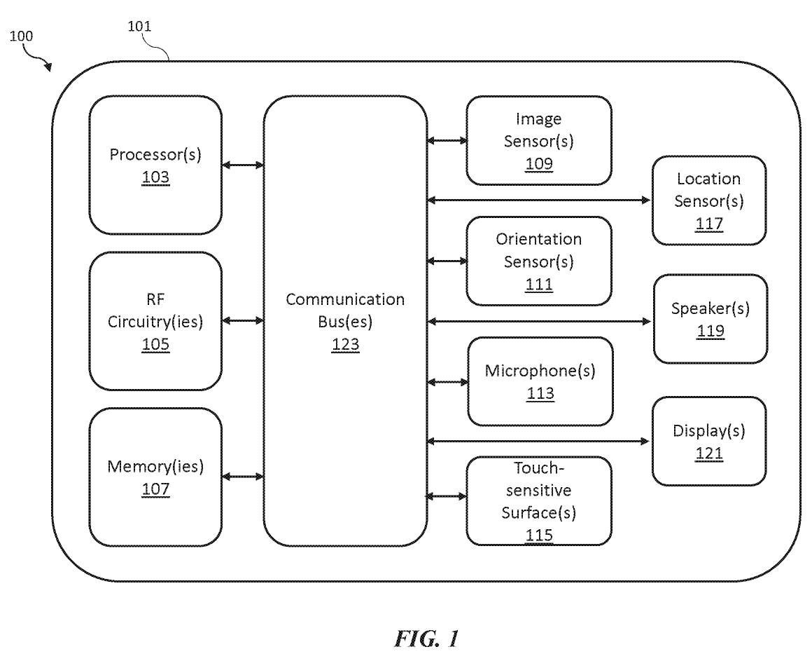

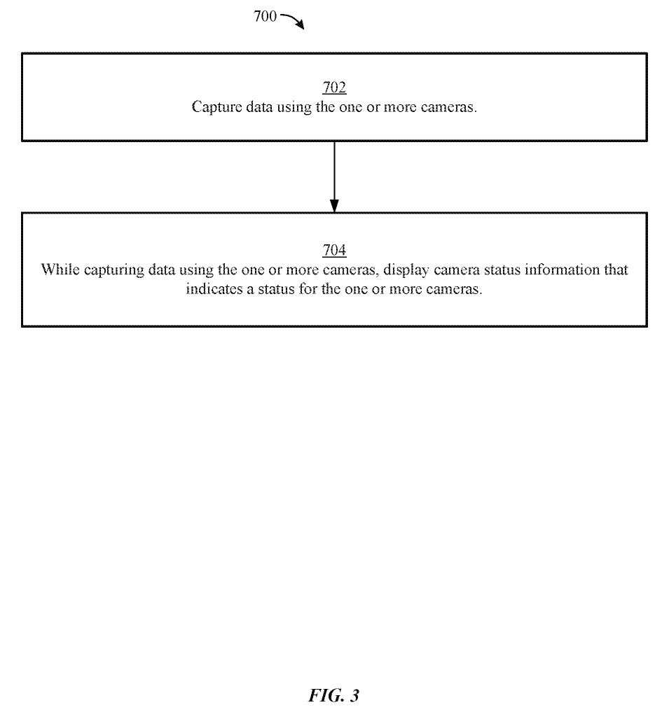

FIG. 1 illustrates an example system 100 for implementing the techniques described herein. System 100 can perform any of the methods described in FIGS. 3, 5, 7, and/or 9 (e.g., methods 700, 900, 1100, and/or 1300) or portions thereof.

In FIG. 1, system 100 includes device 101. Device 101 includes various components, such as processor(s) 103, RF circuitry(ies) 105, memory(ies) 107, image sensor(s) 109, orientation sensor(s) 110, microphone(s) 113, location sensor(s) 117, speaker(s) 119, display(s) 121, and touch-sensitive surface(s) 115. These components optionally communicate over communication bus(es) 123 of device 101. In some embodiments, system 100 includes two or more devices that include some or all of the features of device 101.

In some embodiments, system 100 and/or device 101 is a desktop computer, embedded computer, and/or a server. In some embodiments, system 100 and/or device 101 is a mobile device such as, e.g., a smartphone, smartwatch, laptop computer, and/or tablet computer. In some embodiments, system 100 is a head-mounted display (HMD) device. In some embodiments, system 100 and/or device 101 is a wearable HUD device.

Processor(s) 103 include one or more general processors, one or more graphics processors, and/or one or more digital signal processors. In some embodiments, memory(ies) 107 are one or more non-transitory computer-readable storage mediums (e.g., flash memory and/or random access memory) that store computer-readable instructions configured to be executed by processor(s) 103 to perform the techniques described herein.

RF circuitry(ies) 105 optionally include circuitry for communicating with electronic devices, networks, such as the Internet, intranets, and/or a wireless network, such as cellular networks and wireless local area networks (LANs). RF circuitry(ies) 105 optionally includes circuitry for communicating using near-field communication and/or short-range communication, such as Bluetooth®.

In some embodiments, display(s) 121 include one or more monitors, projectors, and/or screens. In some embodiments, display(s) 121 include a first display for displaying images to a first eye of the user and a second display for displaying images to a second eye of the user. Corresponding images are simultaneously displayed on the first display and the second display. Optionally, the corresponding images include the same virtual objects and/or representations of the same physical objects from different viewpoints, resulting in a parallax effect that provides a user with the illusion of depth of the objects on the displays. In some embodiments, display(s) 121 include a single display. Corresponding images are simultaneously displayed on a first area and a second area of the single display for each eye of the user. Optionally, the corresponding images include the same virtual objects and/or representations of the same physical objects from different viewpoints, resulting in a parallax effect that provides a user with the illusion of depth of the objects on the single display.

In some embodiments, system 100 and/or device 101 includes touch-sensitive surface(s) 115 for receiving user inputs, such as tap inputs and swipe inputs. In some embodiments, display(s) 121 and touch-sensitive surface(s) 115 form touch-sensitive display(s).

Image sensor(s) 109 optionally include one or more visible light image sensors, such as charged coupled device (CCD) sensors, and/or complementary metal–oxide–semiconductor (CMOS) sensors operable to obtain images of physical objects. The image sensor(s), also referred to herein as optical sensor(s), receives light from the environment, projected through one or more lenses, and converts the light to data representing an image. In conjunction with an imaging module (also called a camera module), the image sensor optionally captures still images or video. In some embodiments, the image sensors are used to provide multiple different fixed-focal-length cameras for the device (e.g., camera with different zoom levels and different fields of view that can capture an image or video of a portion of a physical environment of the device with different zoom level and/or different framing). In some embodiments, one or more image sensors are located on the back of device 101, opposite touch-sensitive surface 115 on the front of the device so that a touch screen display on the front of the device is enabled for use as a viewfinder for still and/or video image acquisition. In some embodiments, one or more image sensors are located on the front of the device so that the user’s image is, optionally, obtained for video conferencing while the user views the other video conference participants on the touch screen display. In some embodiments, the position of the image sensor can be changed by the user (e.g., by rotating the lens and the sensor in the device housing) so that a single image sensor is used along with the touch screen display for both video conferencing and still and/or video image acquisition.

Image sensor(s) also optionally include one or more infrared (IR) sensor(s), such as a passive IR sensor or an active IR sensor, for detecting infrared light. For example, an active IR sensor includes an IR emitter, such as an IR dot emitter, for emitting infrared light. Image sensor(s) 109 also optionally include one or more camera(s) configured to capture movement of physical objects. Image sensor(s) 109 also optionally include one or more depth sensor(s) configured to detect the distance of physical objects from system 100. In some embodiments, system 100 uses CCD sensors, cameras, and depth sensors in combination to detect the physical environment around system 100. In some embodiments, image sensor(s) 109 include a first image sensor and a second image sensor. In some embodiments, system 100 uses image sensor(s) 109 to receive user inputs, such as hand gestures. In some embodiments, system 100 uses image sensor(s) 109 to detect the position and orientation of system 100 in the physical environment.

In some embodiments, system 100 and/or device 101 uses microphone(s) 113 to detect sound from the user and/or the physical environment of the user. In some embodiments, microphone(s) 113 includes an array of microphones (including a plurality of microphones) that optionally operate in tandem, such as to identify ambient noise or to locate the source of sound in space of the physical environment.

In some embodiments, system 100 and/or device 101 uses orientation sensor(s) 111 for detecting orientation and/or movement of system 100. For example, system 100 can use orientation sensor(s) 111 to track changes in the position and/or orientation of system 100, such as with respect to physical objects in the physical environment. Orientation sensor(s) 111 optionally include one or more gyroscopes, one or more inertial measurement units, and/or one or more accelerometers.

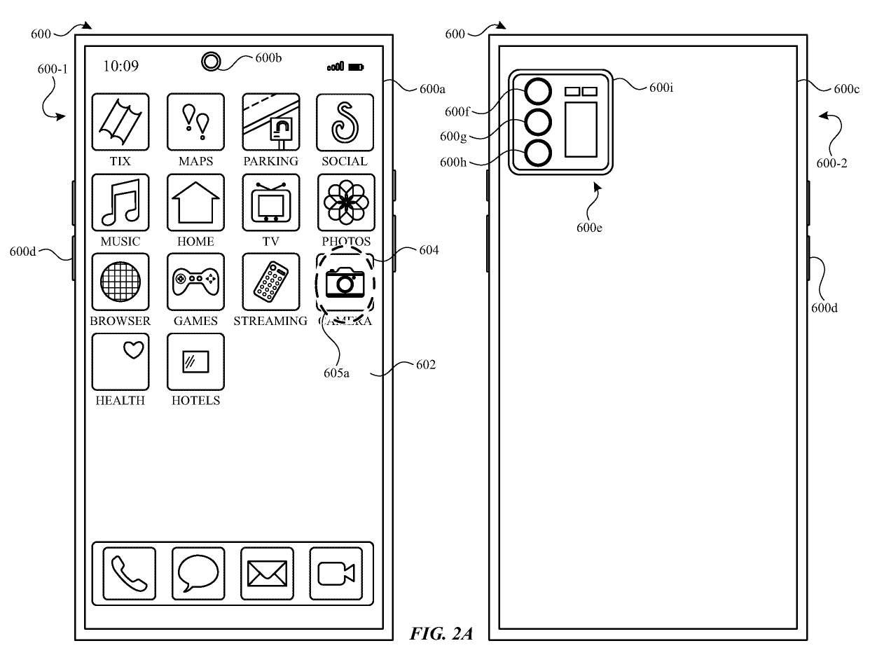

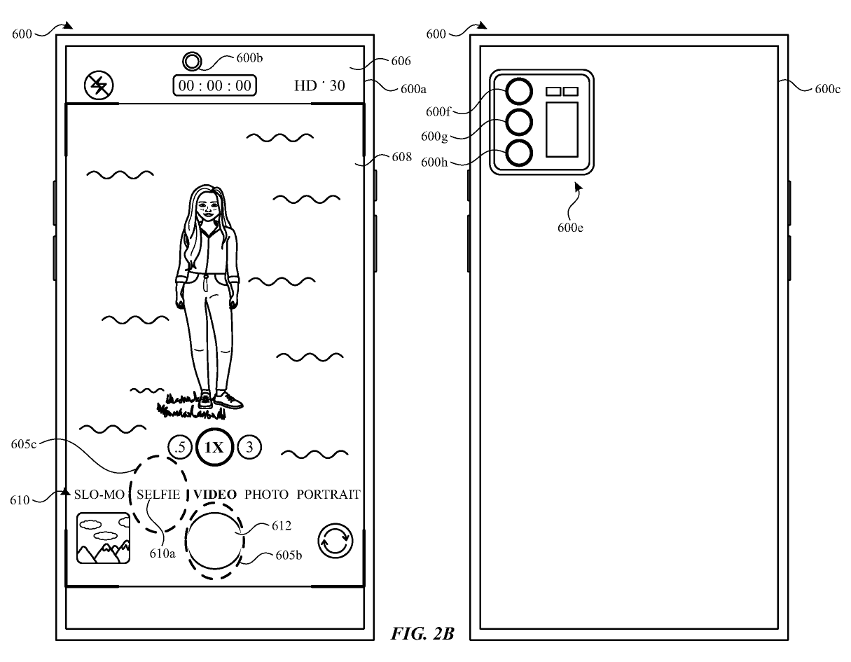

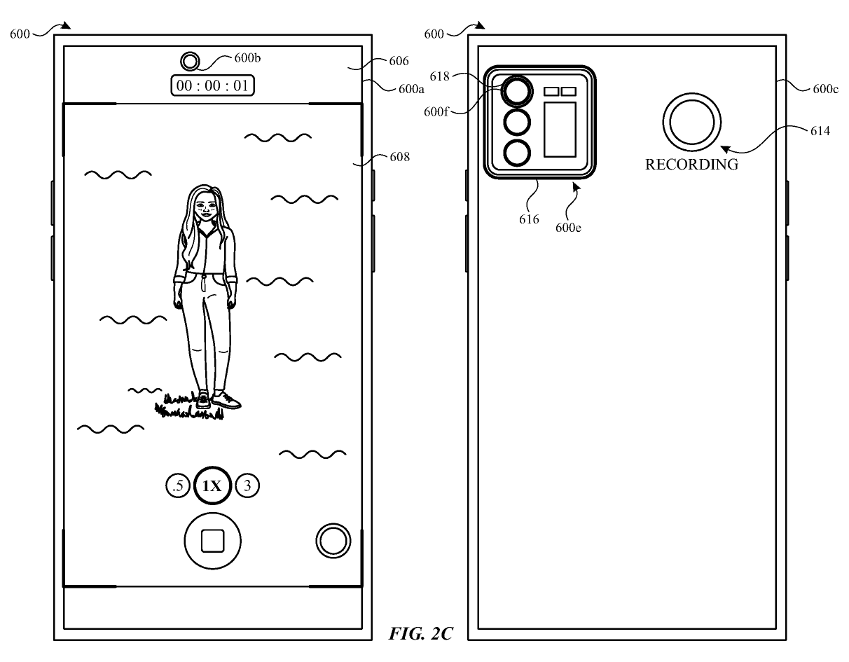

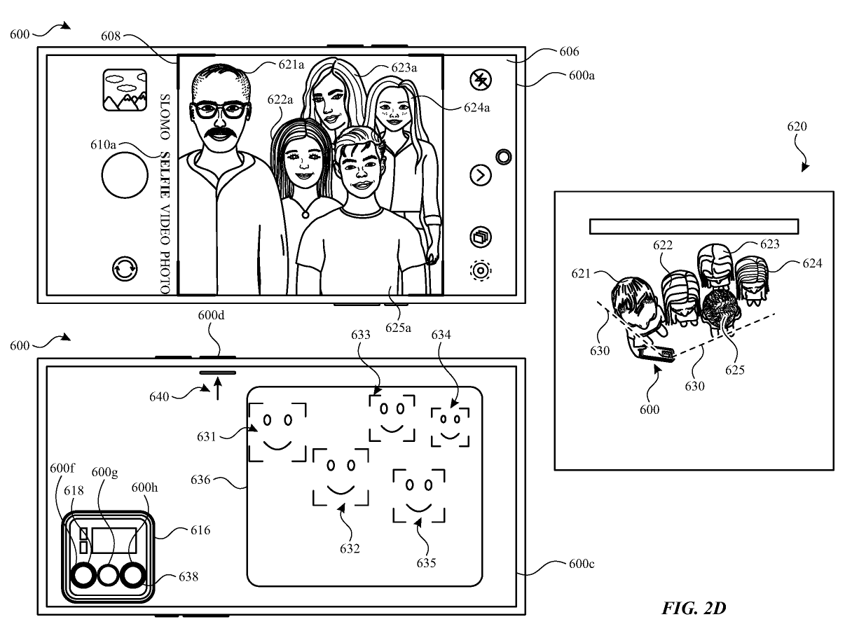

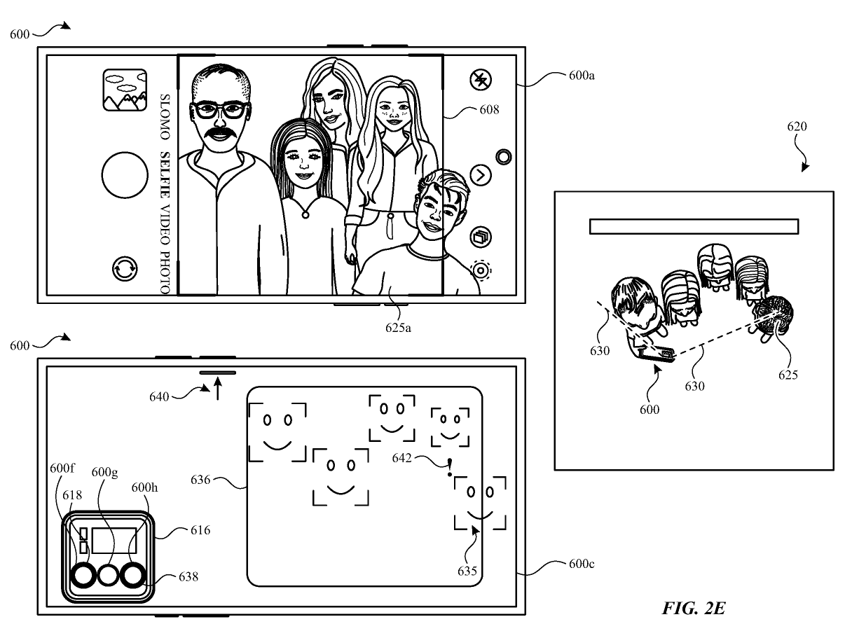

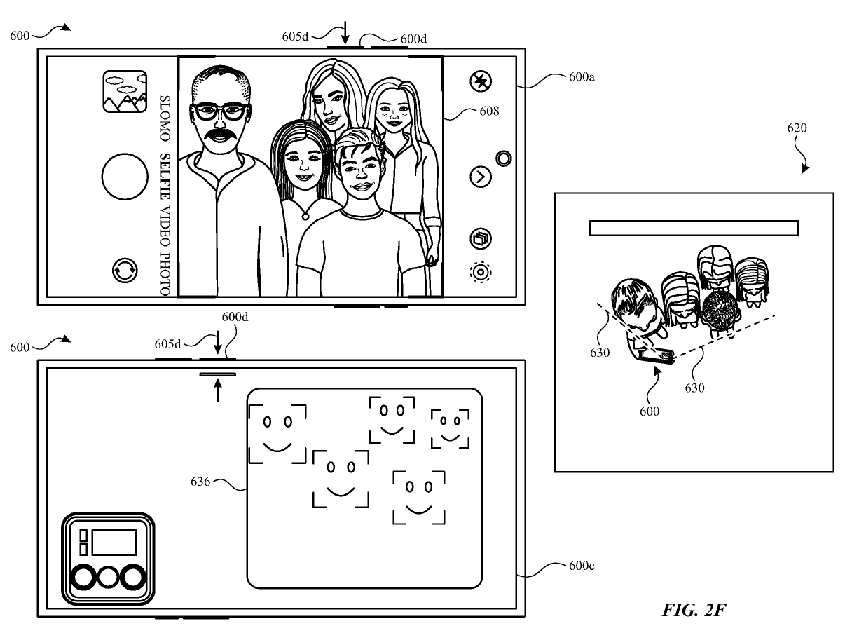

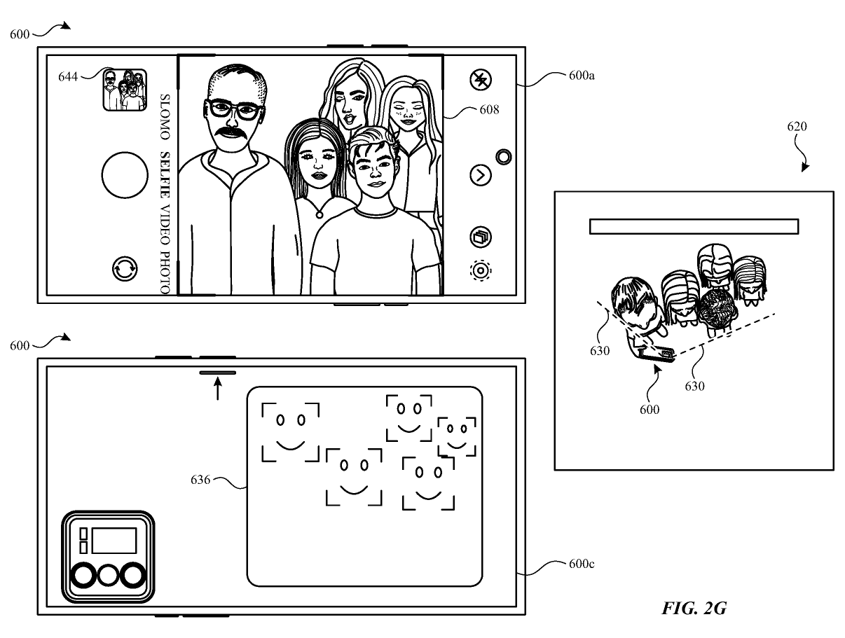

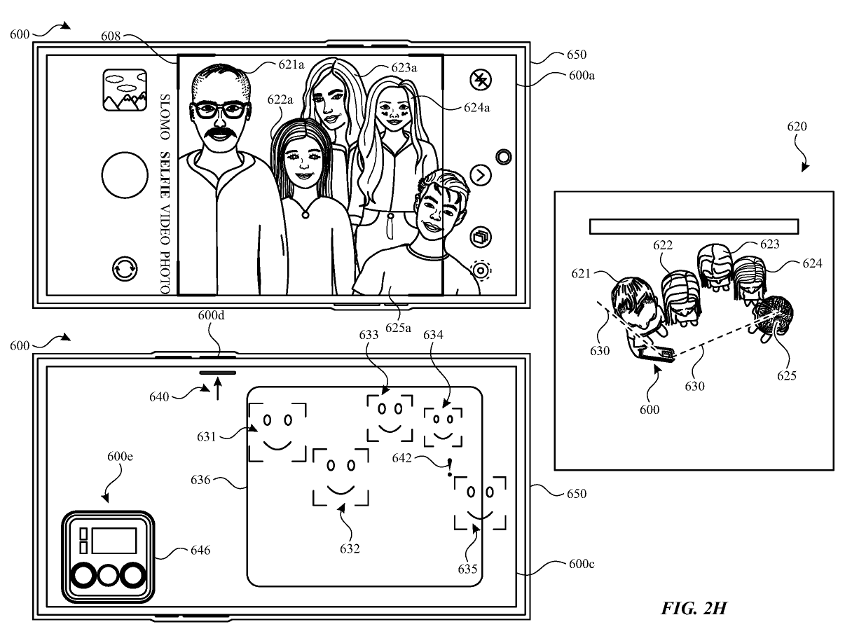

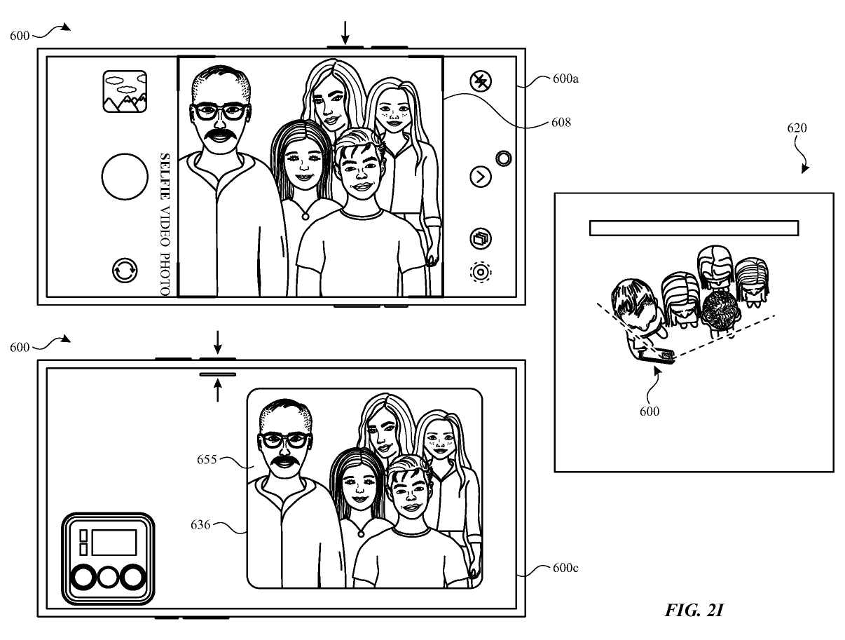

FIGS. 2A-2I illustrate exemplary user interfaces for providing camera feedback using a rear-side display, in accordance with some embodiments. The user interfaces in these figures are used to illustrate the processes described below, including the processes in FIG. 3.

FIG. 2A illustrates front and rear views of computer system 600. Computer system 600 is depicted with front side 600-1 and rear side 600-2. Front side 600-1 of computer system 600 includes display 600a and one or more front cameras 600b. Computer system 600 also includes physical buttons, such as button 600d, located on the side of computer system 600. Display 600a is a high-fidelity, touch-sensitive display component that is used as the primary display for interacting with computer system 600. For example, in FIG. 2A, display 600a is used to display home screen interface 602 and to detect input 605a (e.g., a touch input) selecting camera application icon 604. Front camera 600b is generally used as a user-facing camera while a user interacts with display 600a of computer system 600. For example, front camera 600b can be used as a video camera for recording the user’s video feed during a video call that is displayed using display 600a. However, because front camera 600b is co-located with display 600a on front side 600-1 of computer system 600, front camera 600b generally has limited image and video quality due to a lack of real estate for providing high quality image and optical components, such as larger camera lenses. Front camera 600b can be a lower quality camera for other reasons, such as, for example, to provide a more cost-efficient product or because a lower quality camera is more practical for the intended use of front camera 600b.

FIG. 2A also depicts rear side 600-2 of computer system 600, which includes rear display 600c and rear camera unit 600e. Rear camera unit 600e includes camera lenses 600f, 600g, and 600h, each corresponding to a respective camera of the rear camera unit. A perimeter of rear camera unit 600e is delineated by bezel 600i. In some embodiments, rear camera unit 600e includes display components same as or similar to rear display 600c. In such embodiments, computer system 600 can display content over rear camera unit 600e, as described in greater detail below. The cameras of rear camera unit 600e are of higher quality than front camera 600b. For example, rear camera unit 600e can be used for high quality image photography and video recording, whereas front camera 600b is generally less desirable for these purposes due to the lower image/video quality. Rear display 600c is a low-fidelity display component that is not generally used as a primary display for computer system 600. However, rear display 600c is used to provide dynamic feedback for interacting with computer system 600, thereby increasing efficiency and expanding use capabilities of computer system 600. In FIG. 2A, rear display 600c is not displaying content. In some embodiments, computer system 600 includes one or more components of system 100.

In response to detecting input 605a selecting camera application icon 604, computer system 600 launches the camera application and displays, via display 600a, camera interface 606, as shown in FIG. 2B. Camera interface 606 includes camera preview region 608, which, in some embodiments, is a live camera preview (e.g., camera feed) that depicts a scene captured in the field of view of an active camera. Camera interface 606 also includes camera modes 610 and capture affordance 612. Camera modes 610 can be selected to change a camera mode of computer system 600. In FIG. 2B, a video mode is selected for recording a video using rear camera unit 600e. However, a photo mode can be selected to change from the video mode to a mode for taking a photograph. Capture affordance 612 is selectable to begin recording image and/or video data for the currently selected camera mode.

In response to detecting input 605b selecting capture affordance 612, computer system 600 begins recording a video of the image data captured using rear camera unit 600e, as shown in FIG. 2C. Using display 600a, computer system 600 displays camera interface 606 showing a representation of the video that is being recorded. Computer system 600 also displays recording indicators 614, 616, and 618 using rear display 600c. Recording indicator 614 includes text and/or a graphical object that indicates image data is being recorded, and recording indicators 616 and 618 specify that the cameras on rear side 600-2 are being used to record the video. Specifically, recording indicator 616 surrounds camera bezel 600i and indicates that rear camera unit 600e is active. Similarly, recording indicator 618 surrounds camera lens 600f and indicates that the camera associated with lens 600f is active. The recording indicators provide enhanced privacy considerations by notifying bystanders that one or more cameras of computer system 600 are active. Referring briefly to FIG. 2B, although rear camera unit 600 is active, rear display 600c does not display a recording indicator because the image data captured using rear camera unit 600e is not being recorded (e.g., saved). However, in some embodiments, computer system 600 displays a recording indicator (e.g., recording indicator 616 and/or 618) when rear camera unit 600e is active, even if the image data being captured by the camera unit is not being recorded. In some embodiments, computer system 600 does not display recording indicators using rear display 600c when front camera 600b is active (and rear camera unit 600e is inactive). In some embodiments, recording indicators can be displayed as a border around rear camera unit 600e (e.g., as shown with indicator 616), around individual active lenses (e.g., as shown with indicator 618), or both.

In some embodiments, computer system 600 uses rear display 600c to provide camera feedback. FIGS. 2D-2I illustrate exemplary user interfaces for an embodiment in which a user takes a “selfie” using the higher quality image capabilities of rear camera unit 600e. In FIG. 2D, a “selfie” camera mode is enabled in response to computer system 600 detecting input 605c selecting selfie camera mode option 610a, as shown in FIG. 2B. The selfie camera mode can be activated in other ways, such as, for example, scrolling the camera mode options 610, accessing the selfie camera mode from a different application or user interface (e.g., such as a lock screen), or by using a voice-activated virtual assistant. While in the selfie mode, computer system 600 activates rear camera unit 600e and uses rear display 600c to provide visual feedback to assist a user in taking a selfie using rear camera unit 600e. For example, when the selfie mode is active, computer system 600 activates the cameras corresponding to lens 600g and lens 600h. Accordingly, computer system 600 displays, via rear display 600c, recording indicators 616 and 618, as well as recorder indicator 638, which is displayed around lens 600h to indicate that the camera corresponding to lens 600h is active. Computer system 600 provides additional camera feedback using rear display 600c, as described below. Because the selfie camera mode uses rear camera unit 600e, the user is generally unable to view camera interface 606 and, more importantly, camera preview region 608 when taking the selfie. By providing the feedback using rear display 600c, which is more likely to be visible to the user while taking a selfie, the computer system 600 provides information to the user that assists the user in using the higher quality cameras of rear camera unit 600e to take the selfie, which increases efficiency of using computer system 600 and reduces redundant and excessive processing associated with capturing undesirable photos (e.g., discarding the undesirable photos and retaking additional photos).

In addition to depicting the front side and rear side views of computer system 600 (e.g., shown as turned in a landscape orientation), FIGS. 2D-2I illustrate schematic 620, which provides an overhead view of the environment in which user 621 is taking a selfie with his family, including daughter 622, wife 623, daughter 624, and son 625. Schematic 620 also includes an overhead view of computer system 600 and a representation of a portion (e.g., represented by dashed lines 630) of the field of view of rear camera unit 600e that is captured as part of the selfie photo when the photo is taken. This portion of the field of view is referred to herein as the image frame. In some embodiments, the field of view of rear camera unit 600e extends beyond the image frame. User 621 is holding computer system 600 while taking the photo.

In FIG. 2D, user 621 and his family are positioned within the image frame of rear camera unit 600e, as indicated by the positioning of user 621, daughter 622, wife 623, daughter 624, and son 625 between lines 630 in schematic 620. On the front side display 600a, computer system 600 displays camera interface 606 with representation 621a of user 621, representation 622a of daughter 622, representation 623a of wife 623, representation 624a of daughter 624, and representation 625a of son 625 displayed in camera preview region 608. On rear display 600c, computer system 600 displays border 636, which is an indication of a portion of the camera field of view corresponding to the boundary of camera preview 608. In other words, the region within border 636 represents a region within the image frame, and areas of rear display 600c that are outside of border 636 represent areas that are outside of the image frame.

Computer system 600 also displays, via rear display 600c, representations of faces detected within the field of view of rear camera unit 600e. Computer system 600 displays these representations of detected faces at locations on rear display 600c that correspond to the real time location of the detected face relative to the image frame and relative to other faces detected in the camera field of view. For example, face indicator 631 is a representation of the detected location of the face of user 621 as detected within the field of view of rear camera unit 600e. Because computer system 600 detects the face of user 621 near the top left corner inside the image frame, face indicator 631 is displayed near the top left corner inside of border 636. Similarly, face indicators 632, 633, 634, and 635 correspond to the detected locations of faces of daughter 622, wife 623, daughter 624, and son 625, respectively, and are displayed at locations on rear display 600c corresponding to the relative locations of the corresponding faces within the camera field of view. In some embodiments, the face indicators have the appearance of a line drawing of a simple face positioned inside brackets. In some embodiments, the face indicators can have a different appearance.

Capture affordance 612 can be selected to take the picture, or the picture can be taken by activating (e.g., pressing) button 600d. Computer system 600 displays, via rear display 600c, capture indicator 640, which provides feedback to the user indicating that the image can be captured by activating button 600d. In some embodiments, capture indicator 640 includes an animation of an arrow moving towards a representation of the capture button, which is displayed on rear display 600c at a location near button 600d.

As previously mentioned, face indicators 631-635 displayed on rear display 600c correspond to real time locations of the detected faces relative to the image frame and relative to other faces detected in the camera field of view. Thus, as the people move within the field of view of rear camera unit 600e, computer system 600 detects the movement of the faces and displays the face indicators moving on rear display 600c in real time with the movement of the corresponding faces. For example, in FIG. 2E, son 625 has moved within with the field of view such that the son’s face is partly outside of the image frame as shown in schematic 620 and in camera interface 606. Accordingly, device 600 displays face indicator 635 (e.g., which corresponds to the detected location of the son’s face) moving to the position shown in FIG. 2E, which is located partly outside of border 636 based on the position of the son’s face relative to the image frame. The position of face indicator 635 relative to border 636 corresponds to the positioning of the son’s face relative to the camera preview region, as shown by representation 625a of the son’s face partly outside of camera preview 608. In some embodiments, camera interface 606 displays, in a region outside of camera preview 608, a portion of the camera field of view that is outside of the image frame, which is shown by the portion of representation 625a of son 625 displayed outside the boundary of camera preview 680. Additionally, in response to detecting the position of the son’s face outside of the image frame, computer system 600 displays, via rear display 600c, alert icon 642 adjacent face indicator 635, which indicates that the face corresponding to face indicator 635 is outside of the image frame.

In FIG. 2F, the son’s face has returned to a location within the image frame, and computer system 600 updates rear display 600c accordingly, including moving face indicator 635 within border 636 and ceasing to display alert icon 642. Computer system 600 detects input 605d (e.g., a press input) on button 600d and, in response, captures a photo of the family as depicted in camera preview 680. The captured photo is shown in image preview region 644 in FIG. 2G.

In some embodiments, the rear-display feedback described herein can be displayed using a removable case (e.g., a phone case) that is attached to computer system 600. For example, FIG. 2H depicts an embodiment similar to that shown in FIG. 2E. In this embodiment, computer system 600 causes case 650 to display the rear-display feedback including border 636, face indicators 631-635, recording indicators 616, 618, and 638, and capture indicator 641. Case 650 is attached to computer system 600 and includes low-fidelity display components that are used to display the rear-display feedback in a manner that is analogous to that described herein with respect to rear display 600c. In some embodiments, case 650 includes one or more components of system 100.

In some embodiments, the rear-display feedback described herein can be provided using a camera feed. For example, FIG. 2I depicts an embodiment similar to that shown in FIG. 2F except that the content within border 636 (e.g., face indicators 631-635 and, optionally, alert icon 642) is replaced with camera feed 655. In some embodiments, camera feed 655 is an unaltered representation of the camera feed in camera preview region 608. In some embodiments, camera feed 655 is an altered representation of the camera feed in camera preview region 608 such as, for example, a cropped, zoomed, and/or filtered (e.g., using a low-pass filter) version of the camera feed. The embodiments described herein can be implemented using camera feed 655 in lieu of face indicators 631-635 (or, in some embodiments, in addition to face indicators 631-635). For example, when a detected face is positioned outside of border 636, computer system 600 can display an alert icon same as or similar to alert icon 642 depicted in FIG. 2E to indicate that the face is outside the image frame.

FIG. 3 is a flow diagram illustrating a method for providing camera feedback using a rear-side display of a computer system in accordance with some embodiments. Method 700 is performed at a computer system (e.g., 100 and/or 600) (e.g., a smartphone, a wearable device (e.g., a smartwatch), a tablet computer, a desktop computer, a laptop computer, and/or a head-mounted device (e.g., a head-mounted augmented reality and/or extended reality device)) that is in communication with (e.g., includes and/or is connected to) one or more cameras (e.g., 600e, 600h, 600f, 600g, and/or 600b) (e.g., visible light camera, infrared camera, and/or depth camera) and two or more display generation components, including a first display generation component (e.g., 600a) (e.g., a high-fidelity display, a primary display, a main display, a display controller, a touch-sensitive display system, a display screen, a monitor, a projector, a holographic display, and/or a head-mounted display system) that is located on a first side (e.g., 600-1) of the computer system (e.g., a side of the computer system that primarily faces the user of the computer system when the computer system is being used by the user (e.g., a front side, a front-facing side, and/or a user-facing side of the computer system)) and a second display generation component (e.g., 600c) (e.g., a low-fidelity display, a secondary display, an auxiliary display, a display controller, a touch-sensitive display system, a display screen, a monitor, a projector, a holographic display, and/or a head-mounted display system) that is different from the first display generation component and is located on a second side (e.g., 600-2) of the computer system (e.g., a side of the computer system that primarily faces away from the user of the computer system when the computer system is being used by the user (e.g., a back side, rear-facing side, and/or outward-facing side of the computer system)) that is different from (e.g., opposite and/or juxtaposed) the first side of the computer system, wherein the second display generation component is configured to display content at a lower fidelity (e.g., a lower fidelity, lower definition, lower resolution, smaller range of colors, lower range of greyscale, and/or lower contrast ratio) than the first display generation component (e.g., the first display generation component is configured to display content at a greater fidelity, higher definition, higher resolution, greater range of colors, greater range of greyscale, and/or greater contrast ratio than the second display generation component). In some embodiments, the computer system is also in communication with one or more input devices (e.g., 600d) (e.g., a touch-sensitive surface, a keyboard, mouse, trackpad, a button, one or more optical sensors for detecting gestures, one or more capacitive sensors for detecting hover inputs, and/or accelerometer/gyroscope/inertial measurement units). In some embodiments, an input device is part of a display generation component (e.g., 600a). Some operations in method 700 are, optionally, combined, the orders of some operations are, optionally, changed, and some operations are, optionally, omitted.

As described below, method 700 provides an intuitive way for providing camera feedback using a rear-side display of a computer system. The method reduces the cognitive burden on a user for operating the computer system using the rear-side display, thereby creating a more efficient human-machine interface. For battery-operated computing devices, enabling a user to use a rear-side display to interface with the computer system faster and more efficiently conserves power and increases the time between battery charges.

In method 700, the computer system (e.g., 600) captures (702) data (e.g., image data (e.g., a still image, a video, an image having a plurality of image frames that can be animated upon playback, a live image preview (e.g., in response to opening a camera application) and/or other data)) using the one or more cameras (e.g., 600b, 600e, 600f, 600g, and/or 600h). In some embodiments, capturing the data includes detecting an input, such as an input (e.g., 605a) to launch a camera application, a selection (e.g., 605b) of a capture affordance (e.g., 612) of a camera application, and/or pressing (e.g., 605d) a button (e.g., 600d) for capturing the data.

While capturing data using the one or more cameras (e.g., 600b, 600e, 600f, 600g, and/or 600h), the computer system (e.g., 600) displays (704), via the second display generation component (e.g., 600c), camera status information (e.g., 614, 616, 618, 631, 632, 633, 634, 635, 636, 638, 640, 642, and/or 655) that indicates a status (e.g., a state, a condition, a current status, and/or an operational status) for the one or more cameras (e.g., information about the operational state of the one or more cameras, information about image data captured by the one or more cameras, and/or information about how to operate the one or more cameras) (e.g., without displaying the camera status information via the first display generation component (e.g., 600a)). Displaying, via the second display generation component, camera status information that indicates a status for the one or more cameras provides improved feedback about a state of the computer system.

In some embodiments, displaying the camera status information (e.g., 614, 616, 618, 631, 632, 633, 634, 635, 636, 638, 640, 642, and/or 655) that indicates a status for the one or more cameras (e.g., 600b, 600e, 600f, 600g, and/or 600h) includes updating an appearance of the camera status information over time. Updating an appearance of the camera status information over time provides improved feedback about a state of the computer system (e.g., 600) as the state of the computer system changes over time. In some embodiments, the camera status information changes over time. In some embodiments, the camera status information changes in response to a change in state of the computer system and/or in response to a change in the data captured using the one or more cameras. For example, when a camera is activated, the camera status information changes to indicate which camera and/or camera lens is active (e.g., by introducing the display of a border (e.g., 616, 618, and/or 638) around the activated camera and/or camera lens) or displays an indication (e.g., 614) that a camera of the computer system is in a recording state (e.g., capturing image data). When the camera is deactivated, the computer system stops displaying the border around the camera and/or camera lens and/or stops displaying the indication that the computer system is in the recording state. As another example, when the computer system detects a change in the captured data, such as a change in position of a subject detected in the field of view of the camera, the computer system changes the camera status information (e.g., 631, 632, 633, 634, 635, and/or 655) based on the detected change in the captured data. In some embodiments, the camera status information changes over time to provide feedback to a user of the computer system. For example, the computer system displays an indication (e.g., 640) of a button (e.g., 600d) to be pressed and/or an input gesture for capturing an image using the one or more cameras of the computer system. As another example, the computer system displays an indication of faces (e.g., 631, 632, 633, 634, 635, and/or 655) detected in the camera field of view and an alignment of the faces relative to each other and the camera field of view (and/or predefined portion of the field of view).

In some embodiments, updating the appearance of the camera status information (e.g., 614, 616, 618, 631, 632, 633, 634, 635, 636, 638, 640, 642, and/or 655) over time includes displaying an animation of the camera status information changing from a first appearance (e.g., as shown in FIG. 2D or FIG. 2E) to a second appearance that is different from the first appearance (e.g., as shown in FIG. 2E, FIG. 2F, or FIG. 2I) (e.g., changes in camera status information are animated). Displaying an animation of the camera status information changing from the first appearance to the second appearance that is different from the first appearance provides improved feedback about a state of the computer system (e.g., 600) as the state of the computer system changes over time. In some embodiments, changes in the camera status information are animated. For example, the camera status information includes an animated effect of an arrow (e.g., 640) moving towards a physical button (e.g., 600d) on the computer system to indicate that pressing the physical button will cause the computer system to take a photo. As another example, the camera status information includes representations of faces (e.g., 631, 632, 633, 634, 635, and/or 655) detected in the camera field of view, and the representations of the faces are shown animated, moving relative to a representation of the camera field of view (e.g., 636) (or a representation of a predefined portion of the camera field of view) to indicate movement of the detected faces in the camera field of view.

In some embodiments, updating the appearance of the camera status information (e.g., 614, 616, 618, 631, 632, 633, 634, 635, 636, 638, 640, 642, and/or 655) over time includes displaying movement of one or more user interface elements (e.g., 631, 632, 633, 634, 635, 640, and/or 655) (e.g., graphical elements such as an indication of a face (e.g., 631, 632, 633, 634, and/or 635) detected within the field of view of the one or more cameras, a camera feed (e.g., 655) and/or an indication (e.g., 640) of an input for capturing image data) that are displayed via the second display generation component (e.g., 600c). Displaying movement of one or more user interface elements that are displayed via the second display generation component provides improved feedback about a state of the computer system (e.g., 600) as the state of the computer system changes over time.

In some embodiments, the camera status information (e.g., 631, 632, 633, 634, 635, 636, and/or 655) indicates respective locations of one or more faces detected in a field of view of the one or more cameras (e.g., 600e, 600f, 600g, and/or 600h). Indicating respective locations of one or more faces detected in a field of view of the one or more cameras provides improved feedback about a state of the computer system (e.g., 600), including feedback about locations of faces detected in the field of view of the one or more cameras of the computer system and providing guidance for positioning the faces within the field of view.

In some embodiments, as part of displaying the camera status information (e.g., 614, 616, 618, 631, 632, 633, 634, 635, 636, 638, 640, 642, and/or 655), the computer system (e.g., 600) displays, via the second display generation component (e.g., 600c), a graphical representation (e.g., 636) of a field of view of the one or more cameras (e.g., 600e, 600f, 600g, and/or 600h) (e.g., a border (e.g., 636) representing the boundary of the field of view (or a predefined portion of the field of view that corresponds to an image frame for an image captured using the one or more cameras) of the one or more cameras while the computer system is in a mode for capturing a photo); and displays, via the second display generation component, one or more graphical representations (e.g., 631, 632, 633, 634, and/or 635) of a face detected in the field of view of the one or more cameras (e.g., a first graphical representation of a first face detected in the field of view of the one or more cameras and/or a second graphical representation of a second face, different from the first face, detected in the field of view of the one or more cameras). In some embodiments, the one or more graphical representations of a face are displayed at a location relative to the displayed graphical representation of the field of view of the one or more cameras that corresponds to a location of a face detected in the field of view of the one or more cameras (e.g., the representations of the faces indicate locations of the detected faces relative to the field of view of the one or more cameras). Displaying one or more graphical representations of a face detected in the field of view of the one or more cameras, wherein the graphical representations of the faces are displayed at a location relative to the displayed graphical representation of the field of view of the one or more cameras that corresponds to a location of a face detected in the field of view of the one or more cameras provides improved feedback about a state of the computer system, including feedback about locations of faces detected in the field of view of the one or more cameras of the computer system and providing guidance for positioning the faces within the field of view.

In some embodiments, as a part of displaying the camera status information, the computer system (e.g., 600) displays, via the second display generation component (e.g., 600c) , a first graphical representation (e.g., 631) of a first face (e.g., 621) detected in a field of view of the one or more cameras (e.g., 600e, 600f, 600g, and/or 600h); and displays, via the second display generation component, a second graphical representation (e.g., 635) of a second face (e.g., 625) (different from the first face) detected in the field of view of the one or more cameras. In some embodiments, the first graphical representation of the first face is displayed at a location relative to the second graphical representation of the second face that corresponds to a location of the first face relative to the second face detected in the field of view of the one or more cameras (e.g., the camera status information indicates the locations of faces detected in the field of view of the one or more cameras relative to other faces detected in the field of view of the one or more cameras). Displaying graphical representations of first and second faces detected in the field of view of the one or more cameras, wherein the first graphical representation of the first face is displayed at a location relative to the second graphical representation of the second face that corresponds to a location of the first face relative to the second face detected in the field of view of the one or more cameras provides improved feedback about a state of the computer system, including feedback about locations of faces detected in the field of view of the one or more cameras of the computer system and guidance for positioning the faces relative to each other.

In some embodiments, displaying the camera status information includes, in accordance with a determination that a first set of criteria is met, wherein the first set of criteria is met when a respective face (e.g., 625) is detected having a position that is at least partially outside of a field of view of the one or more cameras (or a predefined portion of the field of view) (e.g., as depicted in FIG. 2E) (e.g., the respective face is detected at a location that is at least partially outside of the field of view (or predefined portion of the field of view) of the one or more cameras or the respective face moves from a position inside of the field of view to a position that is at least partially outside the field of view), displaying a graphical element (e.g., 642) (e.g., an alert and/or warning icon) indicating that one or more faces are at least partially outside of the field of view (e.g., a predefined portion of the field of view that corresponds to an image frame for a captured image) of the one or more cameras. In some embodiments, the graphical element is displayed concurrently with a graphical representation of the face that is at least partially outside the field of view. In accordance with a determination that the first set of criteria is not met, the computer system (e.g., 600) forgoes displaying the graphical element indicating that one or more faces are at least partially outside of the field of view of the one or more cameras. Displaying a graphical element indicating that one or more faces are at least partially outside of the field of view of the one or more cameras when a respective face is detected having a position that is at least partially outside of the field of view of the one or more cameras provides improved feedback about a state of the computer system, including feedback about locations of faces detected in the field of view of the one or more cameras of the computer system and providing guidance for positioning the faces within the field of view. In some embodiments, while the computer system is displaying the graphical element, the computer system detects that the first set of criteria is no longer met (e.g., the face that was detected outside the field of view has moved to a position within the field of view), and, in response, the computer system ceases displaying the graphical element (e.g., as depicted in FIG. 2F).

In some embodiments, the computer system (e.g., 600) is in communication with (or includes) a plurality of cameras lenses (e.g., 600f, 600g, and/or 600h) corresponding to the one or more cameras (e.g., 600e). In some embodiments, displaying the camera status information includes, in accordance with a determination that one or more of the plurality of camera lenses is in an active state (e.g., the camera lens(es) is being used to capture image data), displaying, via the second display generation component (e.g., 600c), an indication (e.g., 614, 616, 618, and/or 638) (e.g., a ring, border, or other visual element that emphasizes the active camera lens(es)) that the one or more of the plurality of camera lenses is in the active state (e.g., indicating which lens(es) of the plurality of lenses is in the active state); and in accordance with a determination that the one or more of the plurality of cameras lenses is not in the active state, forgoing displaying the indication that the one or more of the plurality of camera lenses is in the active state (e.g., the indicator is not displayed for camera lenses that are inactive). Displaying an indication that the one or more of the plurality of camera lenses is in the active state provides improved feedback about a state of the computer system (e.g., a state in which a camera and/or camera lens is active) and provides enhanced security and privacy by indicating that the camera and/or camera lens of the computer system is active. In some embodiments, the computer system includes multiple cameras and the camera status information indicates which cameras are active. For example, in accordance with a determination that one or more of the cameras is in an active state (e.g., the camera is being used to capture image data), the computer system displays, via the second display generation component, an indication (e.g., a ring, border, or other visual element that emphasizes the active camera(s)) that the one or more cameras is in the active state (e.g., indicating which camera of the plurality of cameras is in the active state); and in accordance with a determination that the one or more of the cameras is not in the active state, the computer system forgoes displaying the indication that the one or more cameras is in the active state (e.g., the indicator is not displayed for cameras that are inactive).

In some embodiments, displaying the camera status information includes, in accordance with a determination that the computer system (e.g., 600) is in a first recording state (e.g., the computer system is recording media such as a video and/or audio), displaying, via the second display generation component (e.g., 600c), a recording status indicator (e.g., 614) (e.g., a graphical element that indicates that the computer system is recording media data); and in accordance with a determination that the computer is not in the first recording state (e.g., the computer system is not recording a video and/or audio (e.g., the data captured using the one or more cameras is a live video preview)), forgoing displaying the recording status indicator. Displaying a recording status indicator based on whether the computer system is in a first recording state provides improved feedback about a state of the computer system (e.g., a state in which the computer system is recording media data) and provides enhanced security and privacy by indicating that the computer system is recording media data. In some embodiments, the computer system updates the recording status indicator in response to detecting a change in the recording state (e.g., starting recording or stopping recording). For example, when the computer system begins recording (e.g., using the one or more cameras (e.g., 600b, 600e, 600f, 600g, and/or 600h)), the computer system starts displaying the recording status indicator. Similarly, when the computer system stops recording, the computer system ceases displaying the recording status indicator.

In some embodiments, the camera status information includes an indication (e.g., 640) (e.g., a graphical arrow and/or other visual indicator that is adjacent to the capture input region) of a location of a capture input region (e.g., 600d) (e.g., a hardware or software button for initiating media capture, such as capturing a photo or recording a video). Displaying an indication of a location of a capture input region provides improved feedback about a state of the computer system (e.g., a state in which the computer system is configured to capture media data) and provides guidance to a user of the computer system for capturing media data using the computer system.

In some embodiments, while capturing data using the one or more cameras (e.g., 600b, 600e, 600f, 600g, and/or 600h) and while the camera status information (e.g., 614, 616, 618, 631, 632, 633, 634, 635, 636, 638, 640, 642, and/or 655) is displayed via the second display generation component (e.g., 600c), the computer system (e.g., 600) displays, via the first display generation component (e.g., 600a), respective content (e.g., a camera preview (e.g., 608) and/or a camera user interface (e.g., 606)), wherein the respective content is displayed at a higher fidelity than the camera status information (e.g., the camera status information is displayed at a first fidelity via the second display generation component, and the respective content is concurrently displayed via the first display generation component at a second fidelity that is higher than the first fidelity). Displaying, via the first display generation component, respective content that is displayed at a higher fidelity than the camera status information while capturing data using the one or more cameras and while the camera status information is displayed via the second display generation component provides improved feedback about a state of the computer system.

In some embodiments, the one or more cameras includes a first set of one or more cameras (e.g., 600b) that is located on the first side (e.g., 600-1) of the computer system (e.g., 600) (e.g., front-facing cameras) and a second set of one or more cameras (e.g., 600e, 600f, 600g, and/or 600h) that is located on the second side (e.g., 600-2) of the computer system (e.g., rear-facing cameras). In some embodiments, the second set of one or more cameras have a set of characteristics (e.g., resolution, aperture, low light performance, and/or pixels) that is greater than a set of characteristics of the first set of one or more cameras (e.g., the second set of cameras on the second side are higher quality (e.g., higher resolution, larger aperture, better low light performance, and/or larger pixels) than the first set of one or more cameras on the first side).

In some embodiments, the camera status information (e.g., 614, 616, 618, 631, 632, 633, 634, 635, 636, 638, 640, 642, and/or 655) is displayed in accordance with a determination (or, in some embodiments, in response to detecting) that the computer system (e.g., 600) is in a respective camera mode (e.g., a rear-camera selfie mode and/or a mode in which a rear-facing camera is selected for taking a type of photo). Displaying the camera status information when the computer system is in the respective camera mode provides improved feedback about a state of the computer system. The camera status information is, optionally, displayed in response to detecting that the computer system is in the respective camera mode. In some embodiments, the computer system determines that the computer system has entered the respective camera mode and, in response, displays the camera status information that indicates a status for the one or more cameras.

In some embodiments, the second display generation component is integrated into a structure (e.g., 650) (e.g., a removable or detachable case for the computer system) that surrounds at least a portion of the computer system (e.g., 600). In some embodiments, the second display generation component, optionally, does not change appearance or display content when the structure (e.g., removable case) is removed from the computer system. In some embodiments, the computer system forgoes displaying content via the second display generation component when the structure is not attached to the computer system.

In some embodiments, the second display generation component (e.g., 600c) is integrated into a housing of the computer system (e.g., 600) (e.g., an integrated portion of the computer system). For example, the second display generation component is integrated into a rear-facing or backside surface of a tablet computer, smartphone, or other computer system.

In some embodiments, the camera status information includes a representation (e.g., 655) of the data captured using the one or more cameras (e.g., 600b, 600e, 600f, 600g, and/or 600h) (e.g., a representation of a video feed or image of the one or more cameras). Displaying a representation of the data captured using the one or more cameras provides improved feedback about a state of the computer system (e.g., a state in which the computer system is configured to capture media data) and provides guidance to a user of the computer system for capturing media data using computer system. In some embodiments, the representation of the data (e.g., the video feed or image) is, optionally, filtered through a low-pass filter.

Note that details of the processes described above with respect to method 700 (e.g., FIG. 3) are also applicable in an analogous manner to the methods described below. For example, method 900, method 1100, and/or method 1300 optionally includes one or more of the characteristics of the various methods described above with reference to method 700. For example, a recording indicator can be displayed using the rear-side display in accordance with the embodiments described with respect to method 700. As another example, the content displayed as described in connection with methods 900, 1100, and 1300 can, in some embodiments, be displayed using a removable case for the computer system, as described with respect to method 700. For brevity, these details are not repeated.

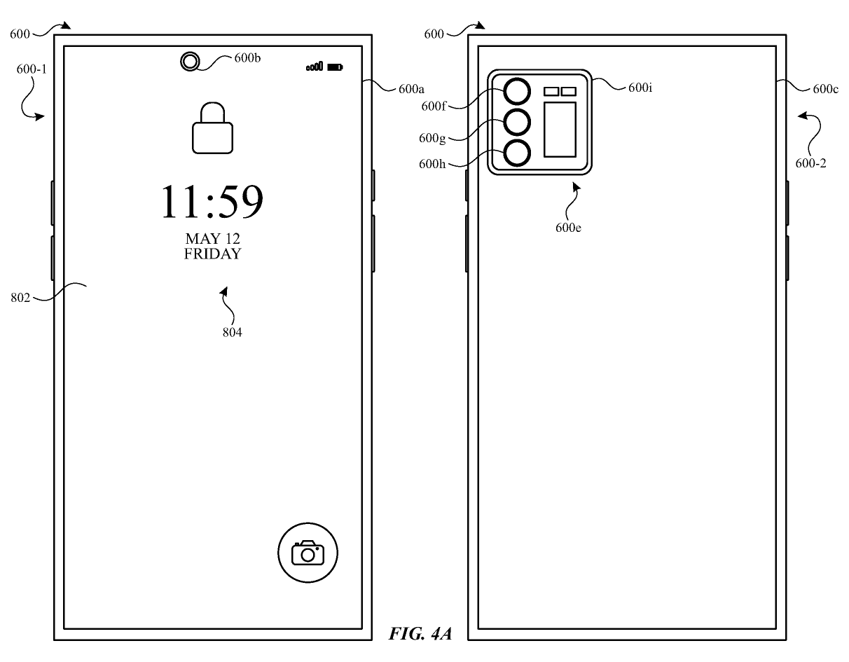

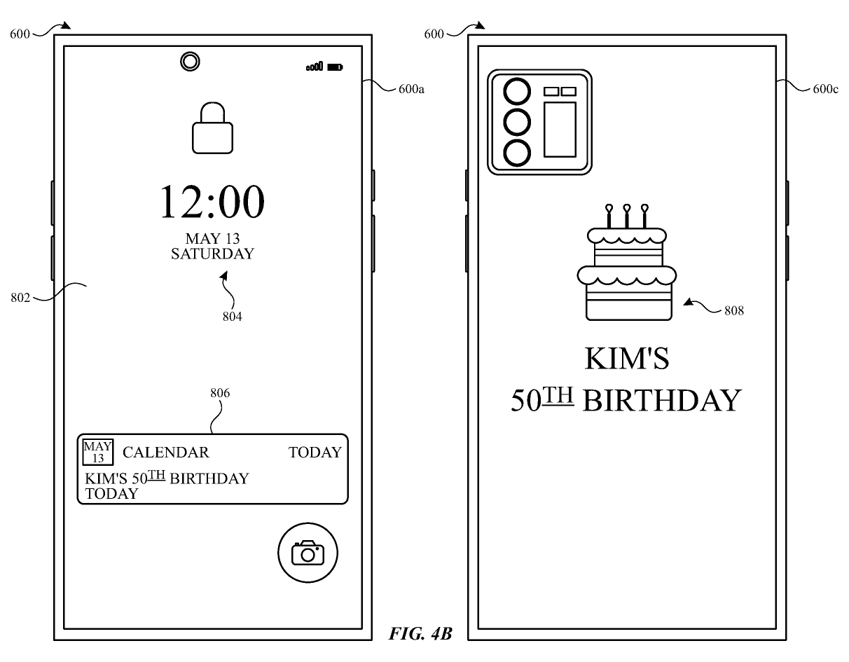

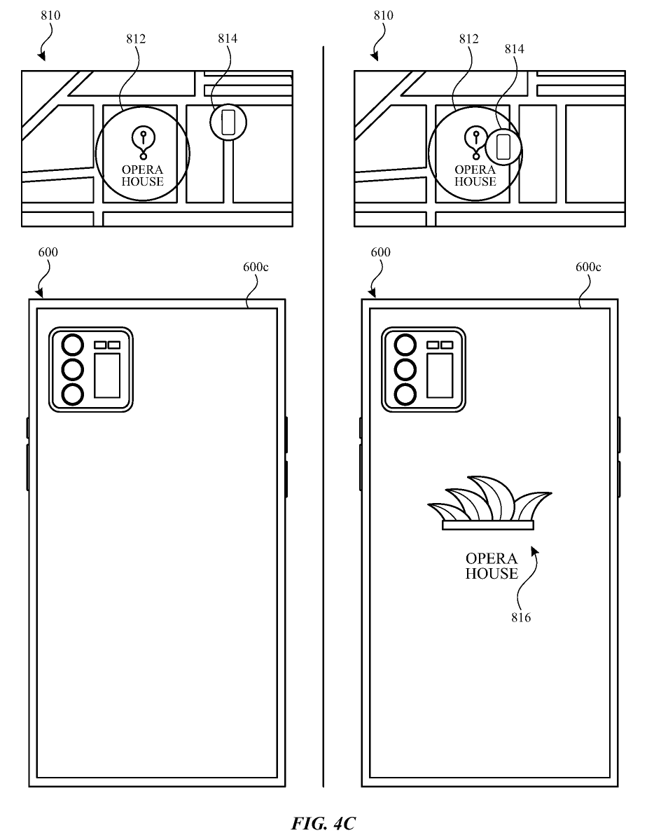

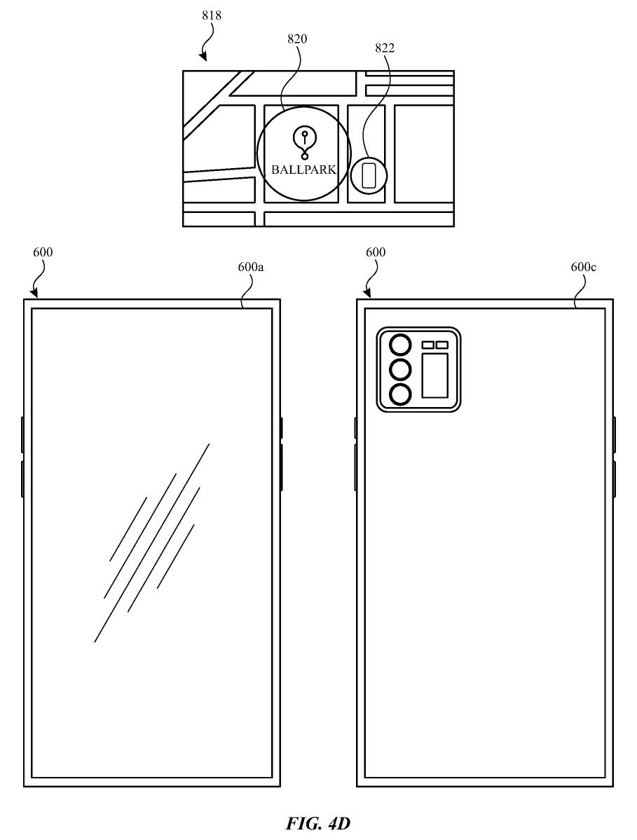

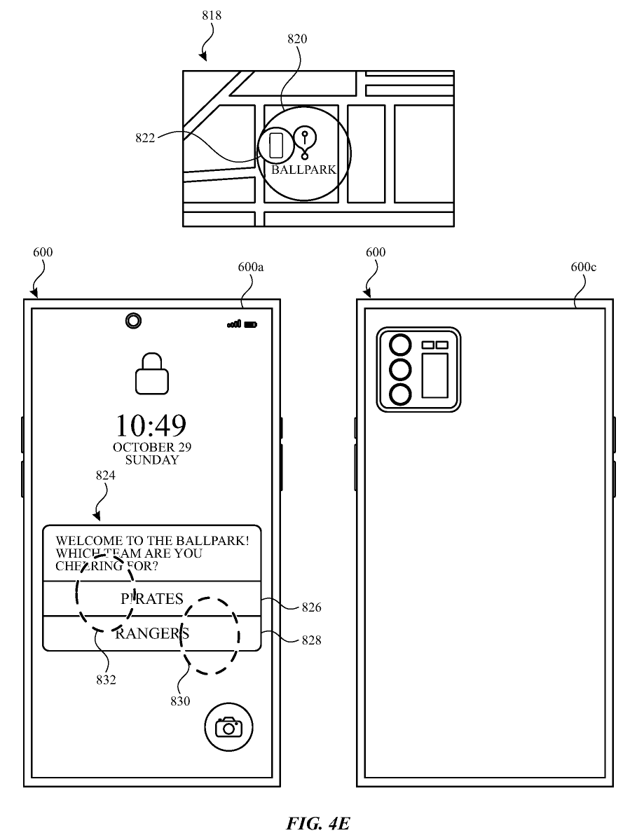

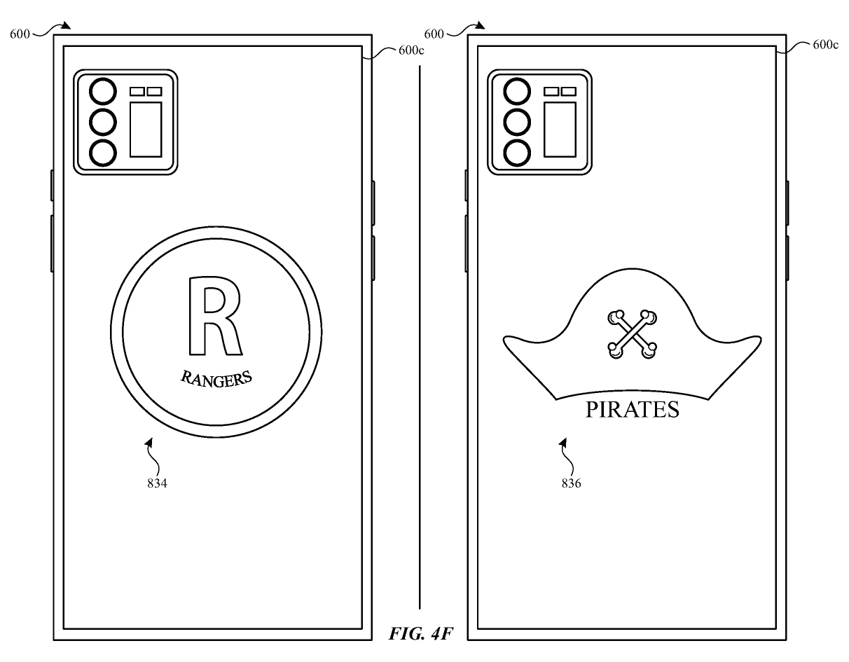

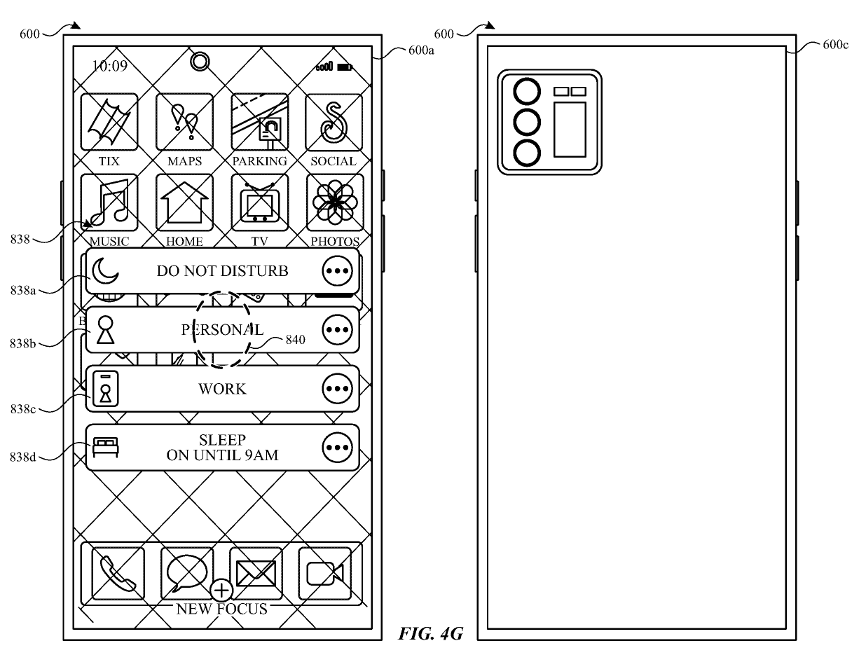

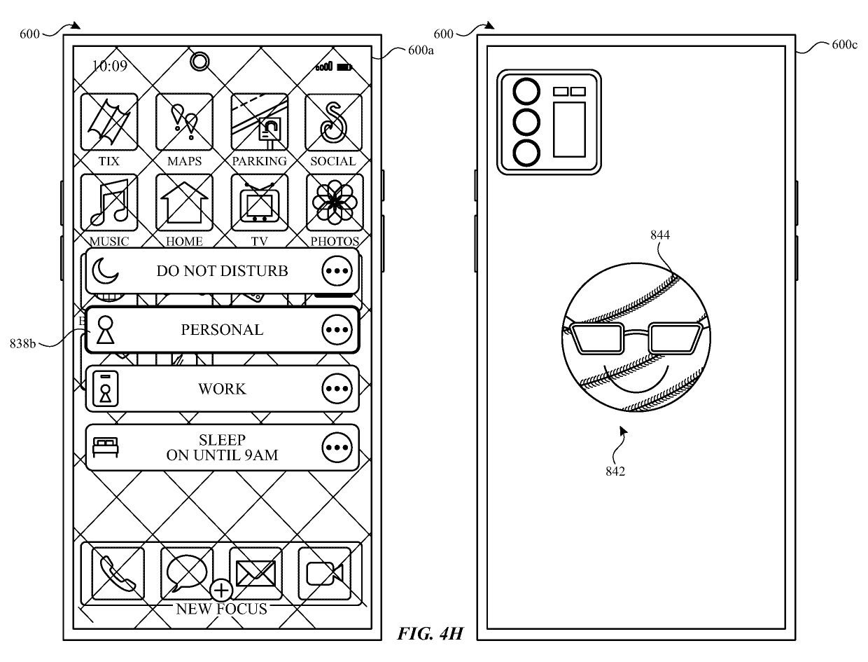

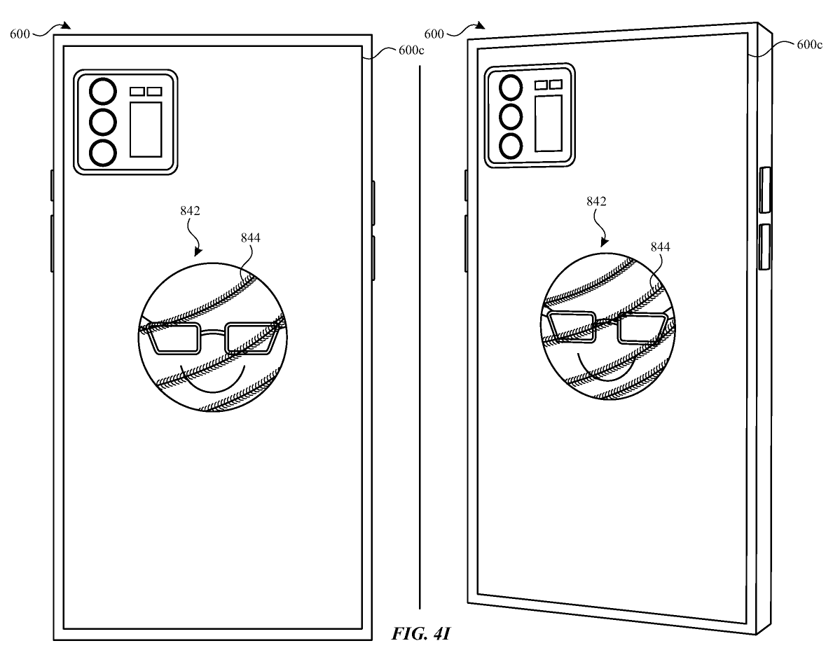

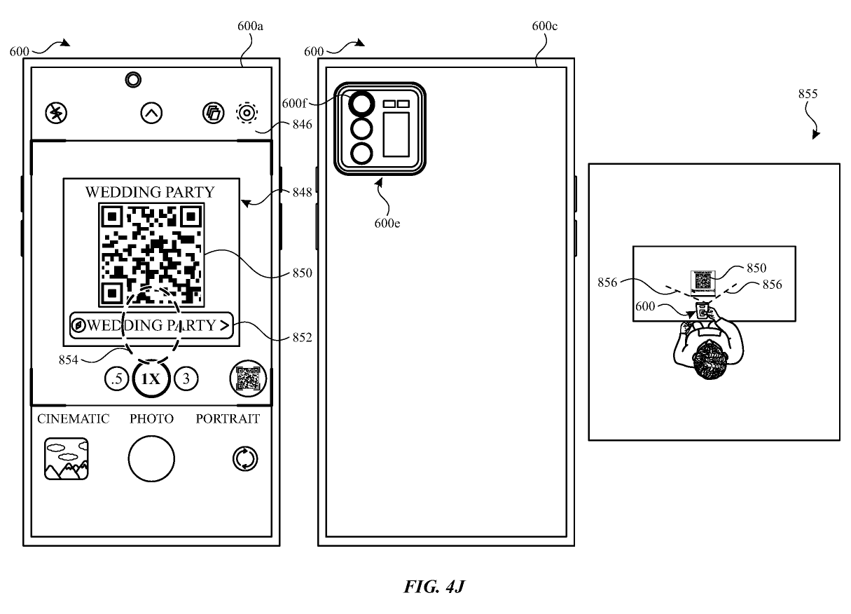

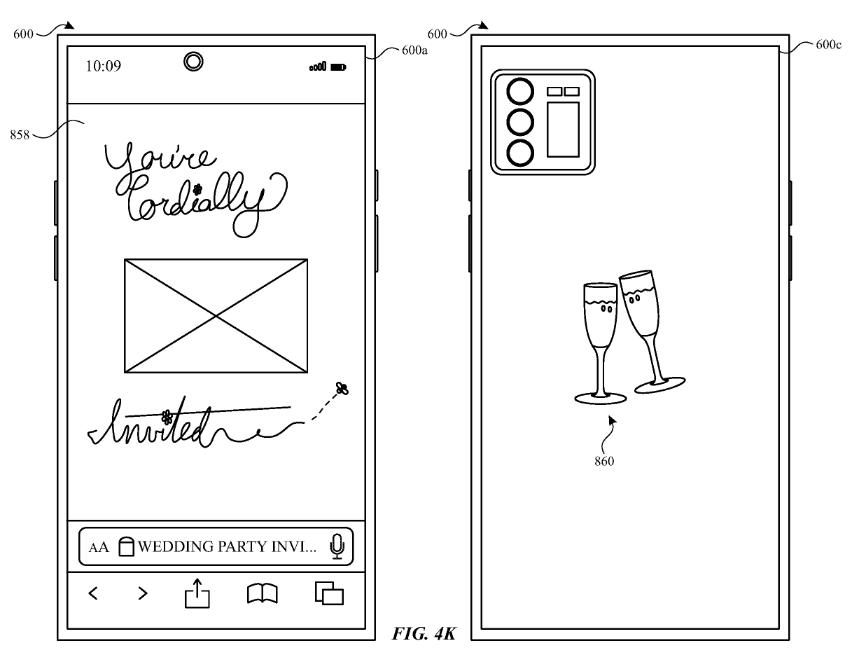

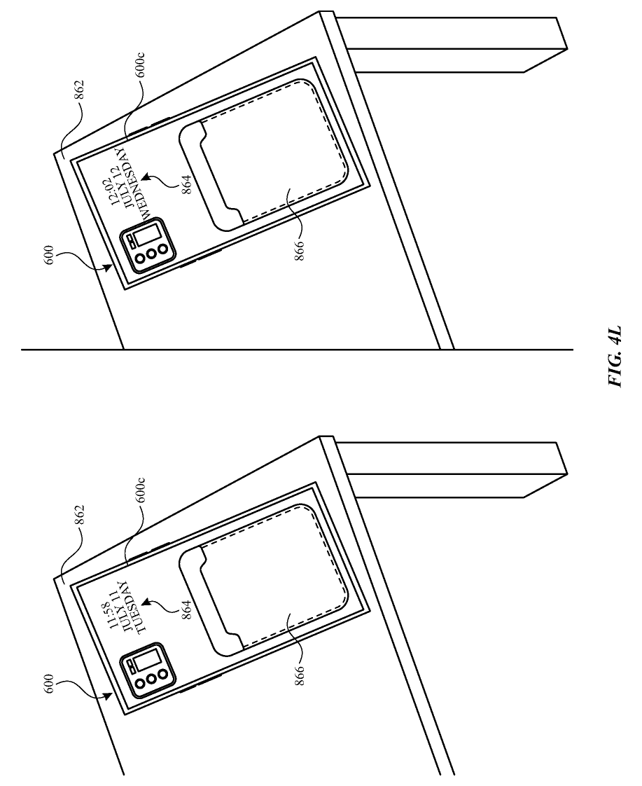

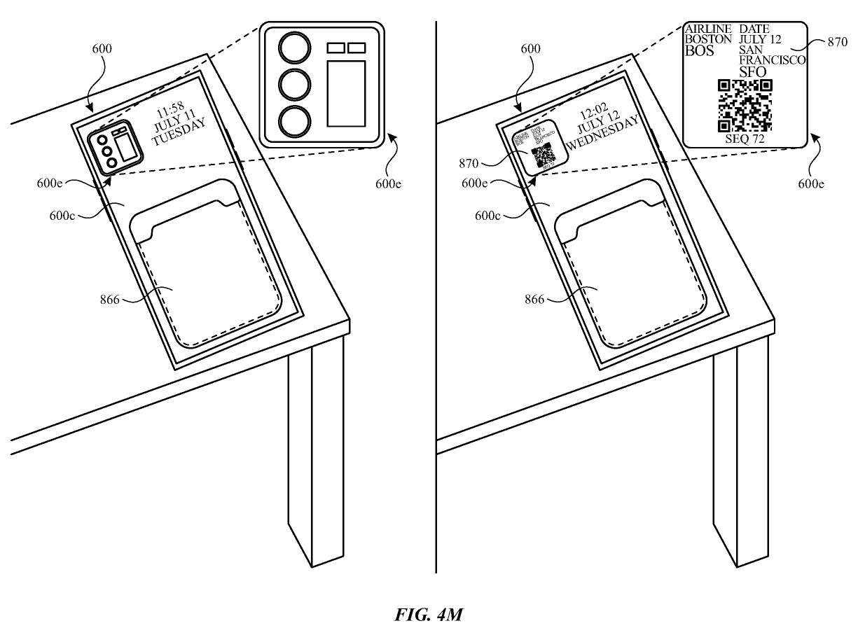

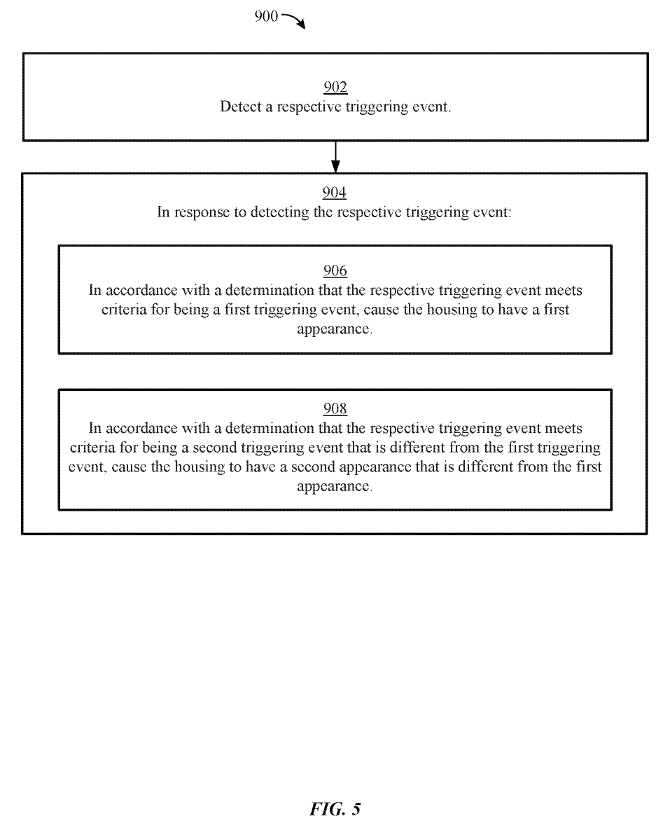

FIGS. 4A-4M illustrate exemplary user interfaces for providing contextual display of a digital decoration using a rear-side display of a computer system, in accordance with some embodiments. The embodiments depicted in FIGS. 4A-4M illustrate various events that trigger the display of a digital decoration that corresponds to the triggering event. The user interfaces in these figures are used to illustrate the processes described below, including the processes in FIG. 5.

FIGS. 4A-4B illustrate an embodiment in which computer system 600 updates rear display 600c to display a digital decoration in response to detecting occurrence of a triggering event that is based on a date and/or time. In this embodiment, the triggering event is a calendar event; however, other events based on a date and/or time can be used to trigger the display of a digital decoration. In FIG. 4A, computer system 600 displays lock screen interface 802 using display 600a and does not display a digital decoration using rear display 600c. The lock screen interface includes date and time information 804, indicating that the current time is 11:59 PM on May 12^{th}. In FIG. 4B, the time has changed to 12:00 AM on May 13^{th}, which corresponds to a calendar item stored at computer system 600. Specifically, the calendar item corresponds to Kim’s birthday, which is May 13^{th}. In response to detecting the change in the date, computer system 600 displays calendar notification 806 using display 600a and displays birthday decoration 808 using rear display 600c. Birthday decoration 808 is a digital decoration displayed on the rear surface of computer system 600 corresponding to the calendar event for Kim’s birthday. In some embodiments, computer system 600 continuously displays birthday decoration 808 for the entirety of May 13^{th} or until the computer system receives user input instructing it to cease display of the decoration. In some embodiments, computer system 600 displays birthday decoration 808 in response to other triggering events, such as when arriving at Kim’s birthday party or after scanning a code at Kim’s birthday party, similar to embodiments described below.

FIG. 4C illustrates an embodiment in which computer system 600 updates rear display 600c to display a digital decoration in response to detecting occurrence of a triggering event that is based on arrival at a location. FIG. 4C depicts map 810 with marker 814 corresponding to the current location of computer system 600 and perimeter 812 corresponding to the location of an opera house. The triggering event is the arrival of computer system 600 at the opera house. FIG. 4C depicts two instances of computer system 600: one in which the computer system is not located at the opera house (as indicated by map 810 with marker 814 positioned outside of perimeter 812) and one in which the computer system is located at the opera house (as indicated by map 812 with marker 814 positioned within perimeter 812). When computer system 600 is not located at the opera house, computer system 600 does not display any digital decoration using rear display 600c. However, when computer system 600 detects arrival at the location of the opera house, computer system 600 displays opera house decoration 816 using rear display 600c, as shown in FIG. 4C. In some embodiments, computer system 600 displays opera house decoration 816 while the computer system is located at the opera house and ceases to display the opera house decoration when the computer system leaves the opera house.

FIGS. 4D-4F illustrate an embodiment in which computer system 600 updates rear display 600c to display a digital decoration in response to detecting occurrence of a triggering event that is based on a user input selecting a displayed option of a user interface. FIGS. 4D and 4E depict map 818 with marker 822 corresponding to the current location of computer system 600 and perimeter 820 corresponding to the location of a ballpark. In FIG. 4D, computer system 600 is not located at the ballpark (e.g., as indicated by the position of marker 822 outside of perimeter 820), and the computer system does not display content on display 600a or rear display 600c. As depicted in FIG. 4E, when the computer system arrives at the ballpark (e.g., as indicated by the position of marker 822 inside perimeter 820), computer system 600 displays notification 824, prompting the user to select which team the user is cheering for. Notification 824 includes Pirates option 826 and Rangers option 828. In FIG. 4E, the computer system displays notification 824 using display 600a and does not display any content using rear display 600c. FIG. 4F depicts computer system 600 displaying, using rear display 600c, a digital decoration corresponding to the option selected in FIG. 4E. In response to detecting input 830 selecting Rangers option 828, computer system 600 displays Rangers logo 834 using rear display 600c. In response to detecting input 832 selecting Pirates option 826, computer system 600 displays Pirates logo 836 using rear display 600c. The embodiment depicted in FIGS. 4D-4F is an example of a digital decoration that can be displayed in response to detecting a user selection of a displayed option. Other digital decorations can be displayed in response to other inputs detected on a displayed user interface of computer system 600.

FIGS. 4G-4I illustrate an embodiment in which computer system 600 updates rear display 600c to display a digital decoration in response to detecting the occurrence of a triggering event that is based on changing an operating mode of computer system 600. In FIG. 4G, computer system 600 displays mode selection interface 838 using display 600a and does not display any digital decoration on rear display 600c. Mode selection interface 838 includes various options that are selectable to set an operating mode of computer system 600. For example, selecting do not disturb option 838a changes the operating mode of the computer system to a mode that silences or suppresses notifications, selecting personal option 838b changes the operating mode to a mode that has been customized by the user, selecting work option 838c changes the operating mode to a mode that suppresses notifications from non-work-related applications, and selecting sleep option 838d changes the operating mode to a mode that uses a dark display and suppresses notifications.

In response to detecting input 840 selecting personal option 838b, computer system 600 changes to the personal operating mode and displays emoji decoration 842 using rear display 600c. In some embodiments, emoji decoration 842 is a user-defined emoji decoration. Emoji decoration 842 includes hatching 844, representing a visual effect such as iridescence or a holographic effect of the displayed emoji decoration. In some embodiments, a displayed digital decoration is responsive to movement of computer system 600. For example, when computer system 600 is tilted as shown in FIG. 4I, the computer system changes the appearance of emoji decoration 842 by shifting the iridescence or holographic effect as indicated by the changes in hatching 844. In some embodiments, a displayed digital decoration can have other visual effects such as a simulated parallax or a simulated shadow that moves based on movement of the computer system. In some embodiments, computer system 600 displays a different digital decoration in response to selecting a different operation mode. For example, a sleeping emoji or a pillow graphic can be displayed using rear display 600c in response to the user selecting sleep option 838d.

FIGS. 4J and 4K illustrate an embodiment in which computer system 600 updates rear display 600c to display a digital decoration in response to detecting the occurrence of a triggering event that is based on scanning a code. FIG. 4J includes schematic 855, which depicts an overhead view of a user using computer system 600 to scan QR code 850 at a wedding to register the user’s attendance or arrival at the wedding. In FIG. 4J, computer system 600 is using one or more of the cameras (e.g., camera 600f) in rear camera unit 600e to capture an image of the QR code (e.g., which is positioned within the camera field of view represented by dashed lines 856 in schematic 855). Accordingly, computer system 600 displays the QR code in camera interface 846, which is displayed using display 600a. Computer system 600 scans QR code 850 and displays link 852, which can be selected to confirm the user’s attendance at the wedding party. In response to detecting input 854 selecting link 852, computer system 600 displays wedding website 858 on display 600a and displays wedding decoration 860 on rear display 600c, as shown in FIG. 4K. In some embodiments, computer system 600 displays wedding decoration 860 in response to scanning QR code 850, regardless of whether the user selects link 852. The embodiment depicted in FIGS. 4J and 4K depicts scanning a QR code, however the computer system can display a digital decoration using rear display 600c in response to other types of code scanning, such as, for example, scanning an NFC code using an NFC reader or other such circuitry (e.g., RF circuitry 105).

FIG. 4L illustrates an embodiment in which computer system 600 updates rear display 600c to display content based on detecting a particular placement of computer system 600. Specifically, computer system 600 displays date and time information 864 in response to detecting a face-down placement of the computer system on table 862. In some embodiments, computer system 600 updates a displayed digital decoration over time. For example, date and time information 864 is updated in real time, as indicated by the time and date change shown in FIG. 4L. In some embodiments, computer system 600 displays date and time information 864 when the face-down placement is detected. In some embodiments, computer system 600 displays date and time information 864 in response to a tap input (or, optionally, a different input) detected while the computer system has the face-down placement. In some embodiments, computer system 600 displays date and time information 864 at a particular location of rear display 600c based on whether portions of the rear display are obstructed. For example, in FIG. 4L, wallet 866 is attached to computer system 600 adjacent to a bottom portion of the rear display, so computer system 600 displays date and time information 864 at an upper region of rear display 600c that is not visually obstructed by the placement of wallet 866. By displaying date and time information 864 using rear display 600c, a user can remain informed of the time without having to use the primary display 600a. For example, if the user is having dinner or meeting with another person, they can position computer system 600 in the face-down position, avoiding the distractions of content such as notifications displayed on display 600a, while still remaining informed of the time through the display of date and time information 864 displayed on rear display 600c.

In some embodiments, computer system 600 displays content over rear camera unit 600e. For example, FIG. 4M depicts an embodiment similar to that in FIG. 4L in which computer system 600 has a face-down placement and displays a boarding pass over the rear camera unit when a triggering event is detected. In the embodiment in FIG. 4M, the user has a flight scheduled for July 12, so when computer system 600 detects the date change to July 12, the computer system displays boarding pass 870 over rear camera unit 600e. In some embodiments, computer system 600 optionally displays the boarding pass over rear camera unit 600e because a significant portion of rear display 600c is visually obstructed by wallet 866. It should be appreciated that the embodiment depicted in FIG. 4M is one example of content that can be displayed over rear camera unit 600e and that computer system 600 can display different content over the rear camera unit. For example, computer system 600 can display the time, battery charge state indicators, an indication of activity progress, information from an application operating at the computer system, or other content that is relevant to a user of computer system 600. Furthermore, the computer system can update the content displayed over the rear camera unit over time. For example, if flight information changes, the computer system updates boarding pass 870 accordingly. In some embodiments, boarding pass 870 includes a QR code or other machine-readable code or data that can be scanned to gain entry. In some embodiments, the boarding pass alternatively includes information indicating that the computer system will provide the data (e.g., boarding pass information) when in proximity to a wireless reader such as, for example, an NFC reader. The boarding pass depicted in the figures and described herein is one example of a digital pass. It should be appreciated that computer system 600 can display other digital passes for accessing an event in an analogous manner.

FIG. 5 is a flow diagram illustrating a method for providing contextual display of a digital decoration using a rear-side display of a computer system in accordance with some embodiments. Method 900 is performed at a computer system (e.g., 100 and/or 600) (e.g., a smartphone, a wearable device (e.g., a smartwatch), a tablet computer, a desktop computer, a laptop computer, and/or a head-mounted device (e.g., a head-mounted augmented reality and/or extended reality device)) that is connected to (e.g., includes, is part of, is attached to, and/or is in communication with) a housing (e.g., 600c and/or 650) (e.g., an integrated portion of the computer system or a part of a removable case for the computer system) that surrounds at least a portion of the computer system. In some embodiments, the computer system is also in communication with one or more input devices (e.g., 600a) (e.g., a touch-sensitive surface, a keyboard, mouse, trackpad, one or more optical sensors for detecting gestures, one or more capacitive sensors for detecting hover inputs, and/or accelerometer/gyroscope/inertial measurement units). In some embodiments, an input device is part of a display generation component (e.g., 600a). In some embodiments, the computer system includes a high-fidelity display generation component (e.g., 600a) (e.g., a high-fidelity display, a primary display, a main display, a display controller, a touch-sensitive display system, a display screen, a monitor, a projector, a holographic display, and/or a head-mounted display system). In some embodiments, the housing includes a low-fidelity display generation component (e.g., 600c) (e.g., a low-fidelity display, a secondary display, an auxiliary display, a display controller, a touch-sensitive display system, a display screen, and/or a head-mounted display system). In some embodiments, the high-fidelity display generation component is located on a first side (e.g., 600-1) (e.g., a front side) of the computer system, and the low-fidelity display generation component of the housing is located on a second side (e.g., 600-2) (e.g., a back side) of the computer system. In some embodiments, the high-fidelity display generation component is configured to display content at a greater fidelity, higher definition, higher resolution, greater range of colors, greater range of greyscale, and/or greater contrast ratio than the low-fidelity display generation component. In some embodiments, the low-fidelity display generation component is configured to display content at a reduced fidelity, lower definition, lower resolution, smaller range of colors, lower range of greyscale, and/or lower contrast ratio as compared to the content displayed via the high-fidelity display generation component. In some embodiments, the low-fidelity display generation component is integrated into the housing (e.g., a case attached to the computer system or an integrated portion of the computer system) that surrounds at least a portion of the computer system. Some operations in method 900 are, optionally, combined, the orders of some operations are, optionally, changed, and some operations are, optionally, omitted.

As described below, method 900 provides an intuitive way for providing contextual display of a digital decoration using a rear-side display of a computer system. The method reduces the cognitive burden on a user for providing contextual display of a digital decoration using a rear-side display of a computer system, thereby creating a more efficient human-machine interface. For battery-operated computing devices, enabling a user to provide contextual display of a digital decoration using a rear-side display of a computer system faster and more efficiently conserves power and increases the time between battery charges.

At method 900, the computer system (e.g., 600) detects (902) a respective triggering event (e.g., a change in location of the computer system, occurrence of a date and/or time, scanning a code, a user selection of an object in a user interface, a change in mode of the computer system, a change in orientation of the computer system, a predefined position of the computer system, and/or an input at the computer system). In response to detecting (904) the respective triggering event, the computer system performs the following steps. In accordance with a determination that the respective triggering event meets criteria for being a first triggering event (or first type of triggering event) (e.g., a change in location of the computer system as depicted in FIG. 4C; an occurrence of a date and/or time as depicted in FIG. 4B; and/or a different triggering event), the computer system causes (906) the housing (e.g., 600c and/or 650) to have a first appearance (e.g., an appearance that includes opera house decoration 816 as depicted in FIG. 4C in response to detecting the change in location of the computer system; an appearance that includes birthday decoration 808 as depicted in FIG. 4B in response to detecting the occurrence of the date and/or time depicted in FIG. 4B; and/or an appearance based on a different triggering event). In some embodiments, in accordance with a determination that the respective triggering event does not meet the criteria for being the first triggering event, the computer system forgoes causing the housing to have the first appearance. In accordance with a determination that the respective triggering event meets criteria for being a second triggering event that is different from the first triggering event (or a second type of triggering event that is different from the first type of triggering event) (e.g., scanning a code as depicted in FIG. 4J, a user selection of a user interface object as depicted in FIG. 4E, and/or a different triggering event), the computer system causes (908) the housing to have a second appearance that is different from the first appearance (e.g., changing an appearance of the housing based on the respective triggering event) (e.g., an appearance that includes wedding decoration 860 as depicted in FIG. 4K in response to scanning the code depicted in FIG. 4J; an appearance that includes Rangers logo 834 or Pirates logo 836 as depicted in FIG. 4F in response to detecting the user selections 830 or 832 in FIG. 4E; and/or an appearance based on a different triggering event). In some embodiments, in accordance with a determination that the respective triggering event does not meet the criteria for being the second triggering event, the computer system forgoes causing the housing to have the second appearance. Causing the housing to have the first appearance in accordance with a determination that the respective triggering event meets criteria for being a first triggering event and causing the housing to have the second appearance in accordance with a determination that the respective triggering event meets criteria for being a second triggering event provides improved feedback about a state of the computer system.

In some embodiments, in response to detecting the respective triggering event, and in accordance with a determination that the respective triggering event meets criteria for being a third triggering event that is different from the first triggering event and the second triggering event (or a third type of triggering event that is different from the first and second types of triggering events) (e.g., a change in a mode of the computer system (e.g., 600), as depicted by the selection of personal option 838b in FIG. 4G, a change in orientation of the computer system as depicted in FIG. 4I, and/or a predefined position or placement of the computer system such as a face-down placement as depicted in FIG. 4L and/or FIG. 4M), the computer system causes the housing (e.g., 600c and/or 650) to have a third appearance that is different from the first appearance and the second appearance (e.g., changing an appearance of the housing based on the respective triggering event being the third triggering event) (e.g., an appearance that includes emoji decoration 842 as depicted in FIG. 4H in response to detecting input 840 selecting personal option 838b in FIG. 4G, an appearance that includes emoji decoration 842 having an altered visual effect 844 in response to detecting the device tilt in FIG. 4I, and/or an appearance that includes displayed date and/or time information 864 as depicted in FIG. 4L in response to detecting the face-down placement of the computer system). Causing the housing to have the third appearance in accordance with a determination that the respective triggering event meets criteria for being a third triggering event provides improved feedback about a state of the computer system. In some embodiments, in accordance with a determination that the respective triggering event does not meet the criteria for being the third triggering event, the computer system forgoes causing the housing to have the third appearance.

In some embodiments, while the housing (e.g., 600c and/or 650) has a current appearance (e.g., an appearance with a displayed digital decoration or an appearance without a displayed digital decoration), and in response to detecting the respective triggering event, in accordance with a determination that the respective triggering event meets criteria for being a fourth triggering event that is different from the first triggering event and the second triggering event (and, in some embodiments, different from the third triggering event) (or a fourth type of triggering event that is different from the first, second, and/or third types of triggering events) (e.g., receiving an email, detecting a change in date and/or time that is not related to a respective triggering event, receiving a video call, receiving an audio call, and/or a different triggering event that does not correspond to a changed housing appearance), the computer system (e.g., 600) forgoes causing the housing to have a changed appearance that is different from the current appearance of the housing (e.g., forgoing changing the appearance of the housing and/or maintaining the current appearance of the housing). In some embodiments, the computer system causes the housing to have a changed appearance in response to some triggering events and does not cause the housing to have a changed appearance in response to other triggering events. In some embodiments, the triggering events that cause the housing to have a changed appearance are predetermined triggering events or triggering events for which the computer system has been configured to cause the housing to have a changed appearance. In some embodiments, triggering events that are not predetermined or triggering events for which the computer system has not been configured to cause the housing to have a changed appearance do not cause the computer system to change the appearance of the housing.

In some embodiments, the respective triggering event is a change in location of the computer system (e.g., 600) (e.g., as depicted in FIG. 4C). In some embodiments, the respective triggering event meets the criteria for being the first triggering event when the changed location of the computer system corresponds to a first predetermined location (e.g., 812) (e.g., the computer system is located at the first predetermined location). In some embodiments, the respective triggering event does not meet the criteria for being the first triggering event when the changed location of the computer system does not correspond to the first predetermined location (e.g., the computer system is not located at the first predetermined location). In some embodiments, the respective triggering event meets the criteria for being the second triggering event when the changed location of the computer system corresponds to a second predetermined location (e.g., the computer system is located at the second predetermined location and/or is not located at the first predetermined location). In some embodiments, the respective triggering event does not meet the criteria for being the second triggering event when the changed location of the computer system does not correspond to the second predetermined location (e.g., the computer system is not located at the second predetermined location). Causing the housing to have the first appearance when the changed location of the computer system corresponds to the first predetermined location and causing the housing to have the second appearance when the changed location corresponds to the second predetermined location provides improved feedback about a state of the computer system (e.g., a state of location of the computer system). In some embodiments, the respective triggering event is based on a current location of the computer system. In some embodiments, the respective triggering event is detected when the computer system arrives at a predetermined location or when the user “checks in” at a predetermined location or event (e.g., using a social media account or other user account). In some embodiments, the predetermined location is associated with an event such as a sporting event or a birthday party. In some embodiments, the location is a user-defined location, such as a user-defined geofence.

In some embodiments, the respective triggering event is based on a date and/or time (e.g., based on a calendar event (e.g., 806) (e.g., an event saved in a calendar application for the computer system (e.g., 600)) and/or a change in time and/or date (e.g., 804) associated with the computer system). In some embodiments, the respective triggering event meets the criteria for being the first triggering event when a date and/or time (e.g., 804) associated with the computer system (e.g., the device clock and/or calendar) corresponds to a first predetermined date and/or time (e.g., the date and/or time associated with the computer system is within a first predetermined timeframe and/or date). In some embodiments, the respective triggering event does not meet the criteria for being the first triggering event when the date and/or time associated with the computer system does not correspond to the first predetermined date and/or time (e.g., the date and/or time associated with the computer system is not within the first predetermined timeframe and/or date). In some embodiments, the respective triggering event meets the criteria for being the second triggering event when the date and/or time associated with the computer system corresponds to a second predetermined date and/or time (e.g., the date and/or time associated with the computer system is within a second predetermined timeframe and/or date). In some embodiments, the respective triggering event does not meet the criteria for being the second triggering event when the date and/or time associated with the computer system does not correspond to the second predetermined date and/or time (e.g., the date and/or time associated with the computer system is not within the second predetermined timeframe and/or date). Causing the housing to have the first appearance when the date and/or time associated with the computer system corresponds to a first predetermined date and/or time and causing the housing to have the second appearance when the date and/or time associated with the computer system corresponds to the second predetermined date and/or time provides improved feedback about a state of the computer system.

In some embodiments, the respective triggering event includes scanning a respective code (e.g., 850) (e.g., scanning an NFC code using RF circuitry 105 and/or scanning a QR code using a camera (e.g., 600e) of the computer system). In some embodiments, the respective triggering event meets the criteria for being the first triggering event when the respective code corresponds to a first code (e.g., the first code is associated with content to be displayed when the housing has the first appearance and/or the scanning of the first code causes the computer system to cause the housing to have the first appearance). In some embodiments, the respective triggering event does not meet the criteria for being the first triggering event when the respective code does not correspond to the first code. In some embodiments, the respective triggering event meets the criteria for being the second triggering event when the respective code corresponds to a second code different from the first code (e.g., the second code is associated with content to be displayed when the housing has the second appearance and/or scanning the second code causes the computer system to cause the housing to have the second appearance). In some embodiments, the respective triggering event does not meet the criteria for being the second triggering event when the respective code does not correspond to the second code. Causing the housing to have the first appearance when the respective code corresponds to the first code and causing the housing to have the second appearance when the respective code corresponds to the second mode provides improved feedback about a state of the computer system (e.g., a state in which the first or second code was scanned). In some embodiments, the respective triggering event is based on a code that is scanned by the computer system. For example, the respective code corresponds to an event such as a wedding, and upon scanning the code, the computer system causes the housing to display a graphic (e.g., 860) that corresponds to the wedding. As another example, the respective code corresponds to a birthday party, and upon scanning the code, the computer system causes the housing to display a graphic (e.g., 808) that corresponds to the birthday party.

In some embodiments, the respective triggering event is an input (e.g., 830 or 832) (e.g., a tap, gesture, and/or other selection input) directed to a set of one or more options (e.g., 826 and/or 828) (e.g., one or more selectable user interface elements) (e.g., a selection of a mode option and/or a selection of a team option) displayed in a user interface (e.g., 824) (e.g., a user interface face displayed via a display generation component of the computer system). In some embodiments, the computer system (e.g., 600) detects the input directed to an option in the set of one or more options and, in response, causes the housing to have the first appearance or the second appearance (e.g., 834 or 836).

In some embodiments, the computer system (e.g., 600) is in communication with one or more display generation components (e.g., 600a). In some embodiments, prior to detecting the respective triggering event and prior to displaying the set of one or more options (e.g., 826 and/or 828) in the user interface, the computer system detects that a set of criteria is met. In some embodiments, the set of criteria includes a first criterion that is based on a current location of the computer system. In some embodiments, the first criterion is met when the current location of the computer system corresponds to a predetermined location (e.g., 820). In some embodiments, the set of criteria includes a second criterion that is based on a predetermined date and/or time associated with the computer system. In some embodiments, the second criterion is met when a current date and/or time associated with the computer system corresponds to the predetermined date and/or time. In response to detecting that the set of criteria is met, the computer system displays the user interface (e.g., 824) including the set of one or more options. Displaying the user interface, including the set of one or more options in response to detecting that the set of criteria is met, provides improved feedback about a state of the computer system (e.g., a state in which the set of criteria is met).

In some embodiments, the set of one or more options includes a first appearance option (e.g., 826) that is selectable to cause the housing (e.g., 600c and/or 650) to have the first appearance (e.g., 836) (e.g., the selection of the first appearance option is the first triggering event) and a second appearance option (e.g., 828) different from the first appearance option, wherein the second appearance option is selectable to cause the housing to have the second appearance (e.g., 834) (e.g., the selection of the second appearance option is the second triggering event). In some embodiments, the computer system (e.g., 600) detects an input (e.g., 830 or 832) corresponding to the set of one or more options and, in response, in accordance with a determination that the input is a selection of the first appearance option, the computer system causes the housing to have the first appearance; and in accordance with a determination that the input is a selection of the second appearance option, the computer system causes the housing to have the second appearance. In some embodiments, the set of one or more options includes more than two appearance options. For example, in some embodiments, the set of one or more options includes a third appearance option that is selectable to cause the housing to have a third appearance.

In some embodiments, the respective triggering event includes enabling a respective operation mode (e.g., 838) of the computer system (e.g., 600) (e.g., activating an operation mode and/or changing from a first operation mode to a second operation mode). In some embodiments, the computer system has different operation modes that, when activated, automatically configure various settings of the computer system for the selected operation mode. In some embodiments, the respective triggering event meets the criteria for being the first triggering event when the respective operation mode is a first operation mode (e.g., 838b) (e.g., the computer system causes the housing to have the first appearance in response to enabling the first operation mode). In some embodiments, the respective triggering event does not meet the criteria for being the first triggering event when the respective operation mode is not the first operation mode. In some embodiments, the respective triggering event meets the criteria for being the second triggering event when the respective operation mode is a second operation mode (e.g., 838d) different from the first operation mode (e.g., the computer system causes the housing to have the second appearance in response to enabling the second operation mode). In some embodiments, the respective triggering event does not meet the criteria for being the second triggering event when the respective operation mode is not the second operation mode. Causing the housing to have the first appearance when the respective operation mode is the first operation mode and causing the housing to have the second appearance when the respective operation mode is the second operation mode provides improved feedback about a state of the computer system (e.g., a state of operating mode for the computer system).

In some embodiments, the housing (e.g., 600c) is an integrated portion of the computer system (e.g., 600). For example, the housing is a rear-facing or backside surface of a tablet computer or smartphone that is generally not detachable from the rest of the computer system during normal, intended use of the device. In some embodiments, the housing is a removable structure (e.g., 650) (e.g., a removable or detachable case for the computer system) that can be attached to the computer system. In some embodiments, the housing (e.g., 650), optionally, does not change appearance or display content when it is removed from the computer system. In some embodiments, the computer system forgoes causing the housing to have a respective appearance or changing an appearance of the housing when the housing is not attached to the computer system.

In some embodiments, while the housing (e.g., 600c and/or 650) has a respective appearance (e.g., the first appearance, the second appearance, or a different appearance), the computer system (e.g., 600) causes the respective appearance to change over time (e.g., as depicted by the change in time and date information 864 in FIG. 4L). In some embodiments, the appearance of the housing changes over time. Causing the respective appearance of the housing to change over time provides improved feedback about a state of the computer system.

In some embodiments, while the housing (e.g., 600c and/or 650) has an appearance (e.g., 842) (e.g., displaying respective content), the computer system (e.g., 600) detects a change in orientation of the computer system (e.g., a tilt and/or rotational movement of the computer system (e.g., as shown in FIG. 4I), and/or changing between a landscape orientation of the computer system and a portrait orientation of the computer system). In response to detecting the change in orientation of the computer system, the computer system causes the appearance (e.g., 842) of the housing to change (e.g., modifying one or more visual characteristics (e.g., 844) of the respective content) based on the change in orientation of the computer system (e.g., based on a magnitude and/or direction of the movement and/or a change in positional orientation (e.g., changing between landscape and portrait orientation)). Causing the appearance of the housing to change based on the change in orientation of the computer system provides improved feedback about a state of the computer system. In some embodiments, the change in appearance of the housing includes a simulated visual effect such as a holographic effect, an iridescent effect, and/or a simulated parallax effect that changes based on the magnitude and/or direction of movement of the computer system. In some embodiments, the change in appearance of the housing includes reorienting the displayed user interface, text, and/or glyphs.

In some embodiments, the computer system (e.g., 600) causes the housing (e.g., 600c and/or 650) to display a date and/or current time (e.g., 864) when the housing has the first appearance or the second appearance. Causing the housing to display a date and/or current time when the housing has the first appearance or the second appearance provides improved feedback about a state of the computer system. In some embodiments, the respective triggering event includes a respective input at the computer system (e.g., a tap input on the housing), and the first appearance or second appearance of the housing includes information (e.g., a date and/or current time) displayed in response to detecting the respective input at the computer system. Causing the appearance of the housing to include information displayed in response to detecting the respective input at the computer system provides improved feedback about a state of the computer system and provides a convenient display of the information without requiring the further input from the use (e.g., picking up and manipulating the computer system to view the information).

In some embodiments, the respective triggering event includes a respective placement of the computer system (e.g., 600) (e.g., placing the computer system in a particular orientation such as a face-down orientation (e.g., as depicted in FIG. 4L) where a high-fidelity display generation component (e.g., 600a) of the computer system is placed against a surface (e.g., 862)), and the first appearance or second appearance of the housing (e.g., 600c and/or 650) includes information (e.g., 864) (e.g., a date and/or current time) displayed in response to detecting the respective placement of the computer system. Causing the first appearance or the second appearance of the housing to include information displayed in response to detecting the respective placement of the computer system provides improved feedback about a state of the computer system and provides a convenient display of the information without requiring the further input from the use (e.g., picking up and manipulating the computer system to view the information).

In some embodiments, causing the housing (e.g., 600c and/or 650) to have the first appearance or the second appearance includes displaying information (e.g., 864 and/or 870) on a portion of the computer system (e.g., 600) that is part of a back side (e.g., 600-2) of the computer system (e.g., a side of the computer system that primarily faces away from the user of the computer system when the computer system is being used by the user (e.g., a rear-facing side and/or outward-facing side of the computer system) that is different from (e.g., opposite from) a front side (e.g., 600-1) of the computer system). Displaying information on a portion of the computer system that is part of a back side of the computer system provides improved feedback about a state of the computer system. In some embodiments, a high-fidelity display generation component (e.g., 600a) is located on the front side of the computer system and a low-fidelity display generation component (e.g., 600c) is located on the back side of the computer system.

In some embodiments, causing the housing (e.g., 600c and/or 650) to have the first appearance or the second appearance includes displaying information (e.g., 870) on a portion (e.g., 600e) of the computer system that includes one or more cameras of the computer system (e.g., a location that is positioned over (e.g., covering, obscuring, and/or overlapping) one or more hardware cameras of the computer system). Displaying information on a portion of the computer system that includes one or more cameras of the computer system provides improved feedback about a state of the computer system (e.g., a state in which the one or more cameras are inactive).

Note that details of the processes described above with respect to method 900 (e.g., FIG. 5) are also applicable in an analogous manner to the methods described above and/or below. For example, method 700, method 1100, and/or method 1300 optionally includes one or more of the characteristics of the various methods described above with reference to method 900. For example, the computer system can display a digital decoration based on context of the computer system while performing one or more of the methods described with respect to method 700, method 1100, or method 1300. For brevity, these details are not repeated.

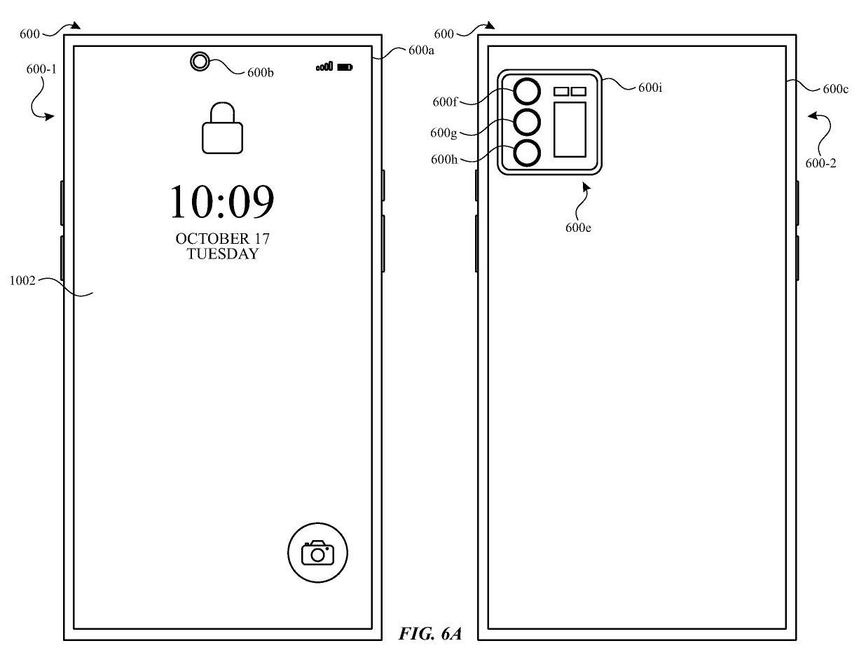

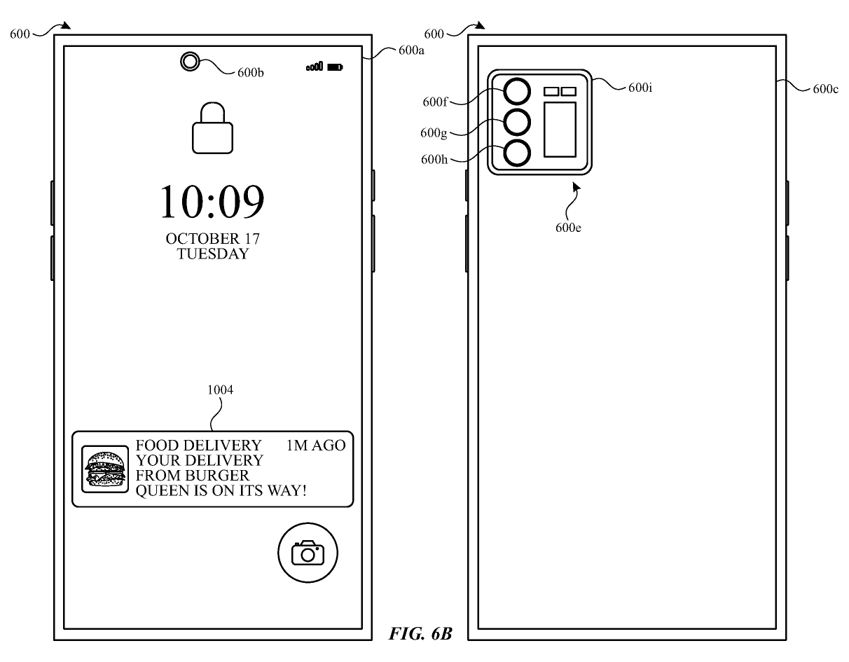

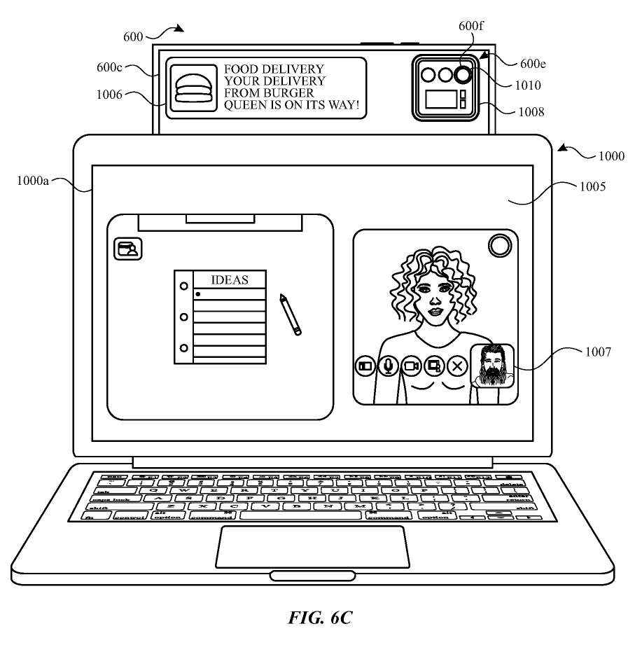

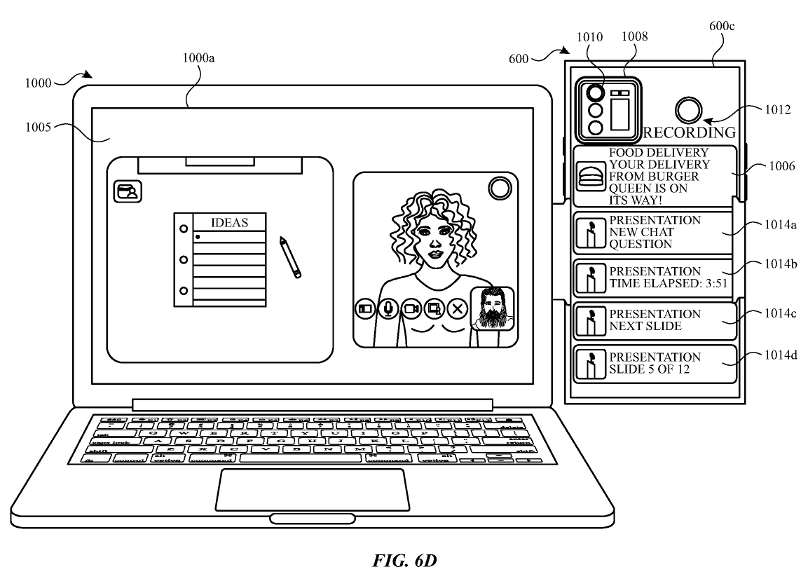

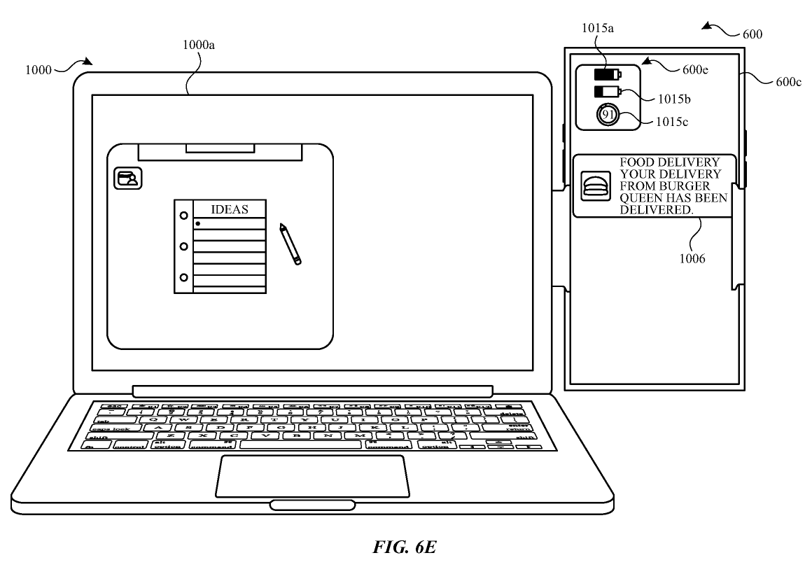

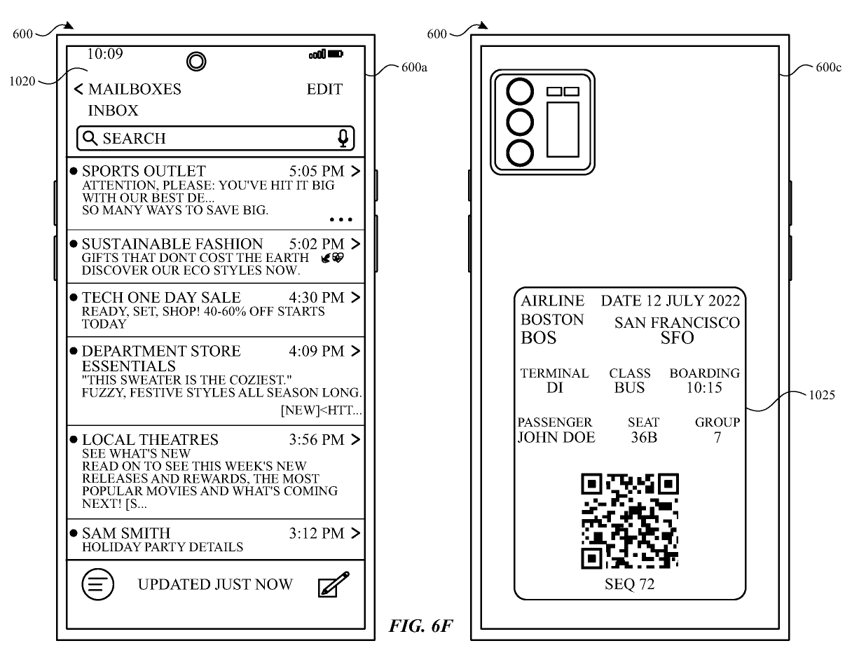

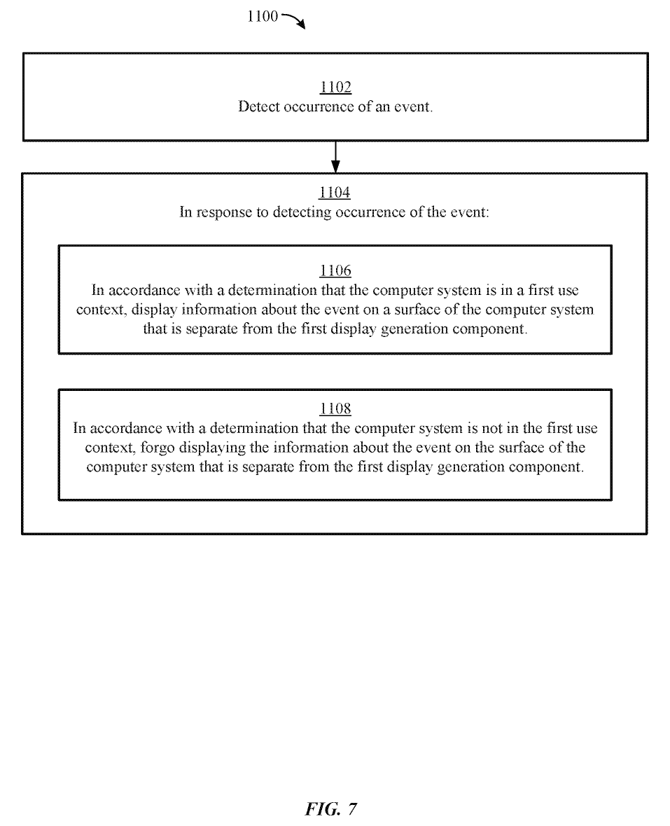

FIGS. 6A-6F illustrate exemplary user interfaces for providing status information using a rear-side display based on a use context of an electronic device, in accordance with some embodiments. The user interfaces in these figures are used to illustrate the processes described below, including the processes in FIG. 7.

FIGS. 6A-6B illustrate an embodiment in which computer system 600 displays content while the computer system is not being used with a companion device. In FIG. 6A, computer system 600 displays lock screen interface 1002 using display 600a and does not display content using rear display 600c. In FIG. 6B, computer system 600 receives data from a food delivery application and displays notification 1004 indicating that food is being delivered. Computer system 600 displays notification 1004 using display 600a because computer system 600 is not being used with a companion device.

FIGS. 6C-6E illustrate embodiments in which computer system 600 displays content using rear display 600c while being used with a companion device. In FIG. 6C, computer system 600 is being used as a companion device with laptop 1000. Specifically, computer system 600 is mounted in landscape orientation to laptop 1000 and is being used as an external camera source for a presentation that is being presented using laptop 1000. Laptop 1000 includes display 1000a, which is being used to display presentation interface 1005 that includes content being shared with other participants of the presentation and video feed 1007, which is a video feed captured using camera 600f of rear camera unit 600e of computer system 600. Because camera 600f of rear camera unit 600e is in use, computer system 600 displays recording indicators 1008 and 1010 (same as or similar to recording indicators 616 and 618) indicating that the camera is in use. In some embodiments, laptop 1000 includes one or more components of system 100.

In FIG. 6C, computer system 600 receives data from a food delivery application similar to that described above with respect to FIG. 6B. However, because computer system 600 is being used as a companion device with laptop 1000, computer system 600 displays notification 1006 using rear display 600c. Notification 1006 provides order status information for food that was ordered using the food delivery application. By displaying notification 1006 (and, in some embodiments, other notifications) using rear display 600c, computer system 600 keeps the user informed of notifications that are received while the computer system is being used as a companion device and, presumably, the user is unable to view the primary display 600a. In some embodiments, however, computer system 600 optionally displays notification 1004 using display 600a (e.g., in addition to displaying notification 1006 via rear display 600c) while computer system 600 is used as a companion device. In the embodiment depicted in FIG. 6C, computer system 600 displays notification 1006 at a location that is not obstructed by laptop 1000, thereby ensuring that the notification is displayed in a location that is visible to the user while computer system 600 is being used with the companion device. In some embodiments, content at computer system 600 is not synced with the companion device. For example, in FIG. 6C, computer system 600 displays notification 1006 using rear display 600c without displaying the notification at laptop 1000.

FIG. 6D depicts another embodiment similar to that in FIG. 6C, except that computer system 600 is mounted in portrait orientation to a side portion of laptop 1000. In FIG. 6D, computer system 600 displays the content on rear display 600c with a different arrangement or appearance because the computer system is in portrait orientation and, in some embodiments, because different portions of the rear display 600c are not obstructed by laptop 1000. For example, notification 1006 is displayed with a different text orientation and text spacing than shown in FIG. 6C. In some embodiments, computer system 600 displays different types of content based on the orientation and/or positioning of computer system 600 while being used with a companion device. For example, in FIG. 6D, computer system 600 displays recording indicator 1012 in addition to recording indicators 1008 and 1010. In some embodiments, computer system 600 displays recording indicator 1012 in lieu of recording indicator 1008 and/or recording indicator 1010. As another example, computer system 600 optionally displays, via rear display 600c, content related to the companion device. For example, in FIG. 6D, computer system 600 displays items 1014 related to the presentation displayed on laptop 1000. Specifically, item 1014a is a notification that a new chat question has been asked by a participant of the presentation; item 1014b informs the user of the time elapsed for the presentation; item 1014c contains information about a next slide in the presentation and/or is selectable to advance the presentation to the next slide; and item 1014d provides presentation progress information.

In FIG. 6E, computer system 600 is still connected to laptop 1000, but the cameras of computer system 600 are no longer active for the presentation. Accordingly, computer system 600 no longer displays recording indicators 1008, 1010, or 1012. Furthermore, because computer system 600 is not being used for the presentation on laptop 1000, the computer system removes items 1014 that were related to the presentation but continues to display content that is unrelated to the presentation, such as notification 1006. As shown in FIG. 6E, computer system 600 updates notification 1006 to indicate a current or updated status of the food order, specifically, indicating that the food order has been delivered. Additionally, computer system 600 displays charge state indicators 1015a, 1015b, and 1015c over rear camera unit 600e. Displaying content over rear camera unit 600e serves at least two purposes: 1) providing feedback indicating that the cameras of rear camera unit 600e are inactive, and 2) providing information from the respective content that is being displayed over rear camera unit 600e. For example, in the embodiment depicted in FIG. 6E, indicator 1015a indicates a battery charge state for computer system 600, indicator 1015b indicates a battery charge state for laptop 1000, and indicator 1015c indicates a battery charge state for a smartwatch that is connected to computer system 600. As the charge states for the respective devices change, computer system 600 updates the corresponding battery charge state indicators so that the indicators provide current charge status information. In some embodiments, computer system 600 ceases to display the content over rear camera unit 600e when one or more of the cameras are activated.

FIG. 6F illustrates an embodiment in which computer system 600 displays content using rear display 600c while the computer system is being used for a purpose that is unrelated to the content that is displayed using rear display 600c. In the embodiment depicted in FIG. 6F, computer system 600 displays email interface 1020 using display 600a and displays boarding pass 1025 using rear display 600c. Accordingly, computer system 600 enables a user to display the boarding pass using the rear display, so that the boarding pass is conveniently available for use, while still enabling the user to use display 600a to perform other, unrelated tasks such as, for example, checking email, browsing the internet, and/or making a phone call. In some embodiments, computer system 600 can display a boarding pass over rear camera unit 600e, the same as or similar to that shown in FIG. 4M. In some embodiments, the boarding pass includes a QR code or other machine-readable code or data that can be scanned to gain entry. In some embodiments, the boarding pass alternatively includes information indicating that the computer system will provide the data (e.g., boarding pass information) when in proximity to a wireless reader such as, for example, an NFC reader. The boarding pass depicted in the figures and described herein is one example of a digital pass. It should be appreciated that computer system 600 can display other digital passes for accessing an event in an analogous manner.

FIG. 7 is a flow diagram illustrating a method for providing status information using a rear-side display based on a use context of a computer system in accordance with some embodiments. Method 1100 is performed at a computer system (e.g., 100 and/or 600) (e.g., a smartphone, a wearable device (e.g., a smartwatch), a tablet computer, a desktop computer, a laptop computer, and/or a head-mounted device (e.g., a head-mounted augmented reality and/or extended reality device)) that is connected to (e.g., includes, is part of, is attached to, and/or is in communication with) a first display generation component (e.g., 600a) (e.g., a primary display, a main display, a high-fidelity display, a display controller, a touch-sensitive display system, a display screen, a monitor, a projector, a holographic display, and/or a head-mounted display system) (in some embodiments, the first display generation component is located on a first side (e.g., 600-1) of the computer system (e.g., a front side, a front-facing side, a user-facing side, and/or a side of the computer system that primarily faces the user of the computer system when the computer system is being used by the user)) (in some embodiments, the first display generation component is a display generation component (e.g., 1000a) of a second computer system (e.g., 1000) (e.g., a companion device) that is different from the computer system (e.g., the computer system is in communication with the first display generation component via the second computer system)) and a second display generation component (e.g., 600c) (e.g., a surface display generation component, a display generation component on and/or embedded in a surface of the computer system, a display generation component on and/or embedded in a housing of the computer system, a display generation component on and/or embedded in a case configured to house the computer system, a secondary display, an auxiliary display, a low-fidelity display, a display controller, a touch-sensitive display system, a display screen, a monitor, a projector, a holographic display, and/or a head-mounted display system) that is different (e.g., separate) from the first display generation component. In some embodiments, the second display generation component is located on a second side (e.g., 600-2) of the computer system (e.g., a side of the computer system that primarily faces away from the user of the computer system when the computer system is being used by the user (e.g., a back side, rear-facing side, and/or outward-facing side of the computer system)) that is different from (e.g., opposite and/or juxtaposed) the first side of the computer system. Some operations in method 1100 are, optionally, combined, the orders of some operations are, optionally, changed, and some operations are, optionally, omitted.

In some embodiments, the computer system (e.g., 600) is also in communication with one or more input devices (e.g., 600a) (e.g., a touch-sensitive surface, a keyboard, mouse, trackpad, one or more optical sensors for detecting gestures, one or more capacitive sensors for detecting hover inputs, and/or accelerometer/gyroscope/inertial measurement units). In some embodiments, an input device is part of a display generation component. In some embodiments, the first display generation component (e.g., 600a and/or 1000a) is configured to display content at a greater fidelity, higher definition, higher resolution, greater range of colors, greater range of greyscale, and/or greater contrast ratio than the second display generation component (e.g., 600c). In some embodiments, the second display generation component is configured to display content at a reduced fidelity, lower definition, lower resolution, smaller range of colors, lower range of greyscale, and/or lower contrast ratio as compared to the content displayed via the first display generation component.

As described below, method 1100 provides an intuitive way for providing status information using a rear-side display based on a use context of a computer system. The method reduces the cognitive burden on a user for managing status information using a rear-side display based on a use context of a computer system, thereby creating a more efficient human-machine interface. For battery-operated computing devices, enabling a user to manage status information using a rear-side display based on a use context of a computer system faster and more efficiently conserves power and increases the time between battery charges.

At method 1100, the computer system (e.g., 600) detects (1102) the occurrence of an event (e.g., receipt of a notification, activation of a camera, receiving data for an application, and/or an input at the computer system). In response (1104) to detecting occurrence of the event, the computer system performs the following steps. In accordance with a determination that the computer system is in a first use context (e.g., in a first use state, being used in a first context, and/or being used as a remote camera for a second computer system), the computer system displays (1106), via the second display generation component (e.g., 600c), information (e.g., 1006) (e.g., text, a graphic, an image, a color, a pattern, and/or an animation) about the event on a surface of the computer system (e.g., a back side of the computer system and/or a housing integrated with or attached to the computer system) that is separate from the first display generation component (e.g., 600a or 1000a). In accordance with a determination that the computer system is not in the first use context, the computer system forgoes (1108) displaying the information about the event on the surface of the computer system that is separate from the first display generation component. Displaying, via the second display generation component, information about the event on a surface of the computer system that is separate from the first display generation component based on whether or not the computer system is in a first use context provides improved feedback about a state of the computer system while the computer system is in the first use context.

In some embodiments, displaying information about the event includes displaying a notification (e.g., 1006) associated with the event on the surface (e.g., 600c) of the computer system (e.g., 600) that is separate from the first display generation component (e.g., 600a and/or 1000a). Displaying a notification associated with the event on the surface of the computer system that is separate from the first display generation component provides improved feedback about a state of the computer system while the computer system is in the first use context. In some embodiments, the notification is associated with an application at the computer system.

In some embodiments, when the computer system (e.g., 600) is in the first use context, the computer system is configured to communicate with an external device (e.g., 1000) (e.g., a companion device) that includes the first display generation component (e.g., 1000a) and is different (e.g., separate and/or distinct) from the computer system (e.g., the external device is a laptop computer, a desktop computer, and/or a monitor, and the computer system is a different device such as a smartphone or tablet); and the notification is not displayed at the first display generation component. Forgoing displaying the notification associated with the event at the first display generation component of the external device provides enhanced privacy by restricting the display of the notification to the surface of the computer system and provides improved feedback about a state of the computer system while the computer system is in the first use context. In some embodiments, the notification is displayed at the computer system but is not displayed at the external device. In some embodiments, while in the first use context, the computer system displays content (e.g., 1014) associated with an application at the external device. In some embodiments, while the computer system is in the first use context, the first display generation component (e.g., 1000a) of the external device (e.g., 1000) is the primary display generation component used during the first use context. In some embodiments, while the computer system is in the first use context, the external device displays content from the computer system (e.g., 1007) (e.g., a video feed captured using one or more cameras of the computer system) but does not display the notification. For example, the notification is specific to an application operating at the computer system and, therefore, is displayed at the computer system but not the external device.

In some embodiments, as a part of displaying information about the event, the computer system (e.g., 600) displays content (e.g., 1014a, 1014b, 1014c, and/or 1014d) (e.g., virtual slideshow information) related to an application (e.g., a presentation application) operating at an external device (e.g., 1000) (e.g., a companion device such as a laptop computer, desktop computer, and/or monitor that is in communication with the computer system when the computer system is in the first use context). Displaying content related to an application operating at an external device provides improved feedback about a state of the external device while the computer system is in the first use context. In some embodiments, when in the first use context, the computer system is in communication with an external device, and the computer system displays content related to an application operating at the external device. For example, the external device is displaying a user interface (e.g., 1005) for a presentation application, and information related to the presentation is displayed at the second display generation component (e.g., 600c) of the computer system (e.g., 600). In some embodiments, the information related to the presentation includes virtual slideshow information, such as a time elapsed for the slideshow presentation, an indication of a next slide in the slideshow, a progress indicator for the slideshow, and/or other information related to the slideshow.

In some embodiments, the computer system (e.g., 600) is in the first use context when the computer system is configured to operate as a remote camera for an external device (e.g., 1000) (e.g., a companion device such as a laptop computer, desktop computer, and/or monitor that is in communication with the computer system when the computer system is in the first use context) that is different from the computer system (e.g., the computer system captures image data using one or more cameras of the computer system and communicates the captured image data to the external device). In some embodiments, the computer system includes one or more cameras (e.g., 600f, 600g, and/or 600h), and the one or more cameras of the computer system are used as a remote camera for the external device when the computer system is in the first use context.

In some embodiments, the computer system (e.g., 600) is in the first use context when the computer system is coupled (physically coupled) to an external device (e.g., 1000) (e.g., a companion device such as a laptop computer, desktop computer, and/or monitor that is in communication with the computer system when the computer system is in the first use context) that is different from the computer system (e.g., the computer system captures image data using one or more cameras of the computer system and communicates the captured image data to the external device). In some embodiments, displaying the information about the event on the surface (e.g., 600c) of the computer system that is separate from the first display generation component (e.g., 600a and/or 1000a) includes, in accordance with a determination that a first portion of the surface is not obscured by (e.g., covered by and/or positioned behind) at least a portion of the external device, displaying the information about the event on the first portion of the surface (e.g., as shown in FIG. 6D); and in accordance with a determination that the first portion of the surface is obscured by at least a portion of the external device, displaying the information about the event on a second portion of the surface that is not obscured by at least a portion of the external device (e.g., as shown in FIG. 6C) (and, in some embodiments, forgoing displaying the information about the event on the first portion of the surface that is obscured by the external device). Displaying the information about the event on the second portion of the surface that is not obscured by at least a portion of the external device, in accordance with a determination that the first portion of the surface is obscured by at least a portion of the external device, reduces inputs at the computer system by performing an operation when a set of conditions has been met without requiring further user input and provides improved feedback about a state of the computer system while the computer system is coupled to the external device. In some embodiments, when the computer system is coupled to a companion device, the computer system displays the information about the event on a respective portion of the surface that is not obscured by the companion device.

In some embodiments, displaying the information about the event on the surface (e.g., 600c) of the computer system (e.g., 600) that is separate from the first display generation component (e.g., 600a and/or 1000a) includes, in accordance with a determination that the computer system has a first orientation (e.g., a portrait orientation), displaying the information (e.g., 1006) about the event on the surface of the computer system in a first displayed format (e.g., as shown in FIG. 6D) (e.g., arrangement, size, orientation, and/or positioning) that is based on the first orientation of the computer system (e.g., displaying the information in a first manner based on the first orientation of the computer system); and in accordance with a determination that the computer system has a second orientation different from the first orientation (e.g., a landscape orientation), displaying the information about the event on the surface of the computer system in a second displayed format (e.g., as shown in FIG. 6C) (e.g., arrangement, size, orientation, and/or positioning) that is different from the first displayed format and is based on the second orientation of the computer system (e.g., displaying the information in a second manner based on the second orientation of the computer system). Displaying the information about the event on the surface of the computer system in a first or second displayed format that is based on the first or second orientation of the computer system reduces inputs at the computer system by performing an operation (e.g., automatically adjusting the displayed format of the information) when a set of conditions has been met without requiring further user input and provides improved feedback about a state of the computer system while the computer system has a respective orientation.

In some embodiments, the computer system (e.g., 600) is in the first use context when the computer system is capturing media data (e.g., capturing image data using one or more cameras of the computer system and/or capturing audio data using one or more microphones of the computer system) and displaying the information about the event on the surface of the computer system that is separate from the first display generation component includes displaying a recording indicator (e.g., 1008, 1010, and/or 1012) (e.g., a graphical indication that the computer system is capturing media data (e.g., using a camera and/or microphone)). Displaying a recording indicator when the computer system is capturing media data provides improved feedback about a state of the computer system while the computer system is in the first use context and provides enhanced security and privacy by informing bystanders that the computer system is capturing media data.

In some embodiments, displaying information about the event on a surface (e.g., 600c and/or 600e) of the computer system (e.g., 600) includes displaying the information (e.g., 1006, 1015a, 1015b, and/or 1015c) on a back side (e.g., 600-2) of the computer system (e.g., a side of the computer system that primarily faces away from the user of the computer system when the computer system is being used by the user (e.g., a rear-facing side and/or outward-facing side of the computer system) that is different from (e.g., opposite from) a front side (e.g., 600-1) of the computer system). Displaying the information on a back side of the computer system provides improved feedback about a state of the computer system. In some embodiments, a high-fidelity display generation component (e.g., 600a) is located on the front side of the computer system and a low-fidelity display generation component (e.g., 600c) is located on the back side of the computer system.

In some embodiments, displaying information about the event on a surface (e.g., 600c and/or 600e) of the computer system (e.g., 600) includes displaying the information on a portion (e.g., 600e) of the computer system that includes one or more cameras (e.g., 600f, 600g, and/or 600h) of the computer system (e.g., a location that is positioned over (e.g., covering, obscuring, and/or overlapping) one or more hardware cameras of the computer system). Displaying the information on a portion of the computer system that includes one or more cameras of the computer system provides improved feedback about a state of the computer system (e.g., a state in which the one or more cameras are inactive).

In some embodiments, the computer system (e.g., 600) is in the first use context when the computer system has a face-down placement (e.g., as depicted in FIGS. 4L and 4M) (e.g., the computer system is placed in a face-down orientation where a high-fidelity display generation component (e.g., 600a) of the computer system is placed against a surface (e.g., 862) or is facing down relative to the earth’s gravitational pull).

In some embodiments, displaying information about the event includes displaying charge state information (e.g., 1015a, 1015b, and/or 1015c) (e.g., a graphical representation of information about a charge state or status for a battery of the computer system and/or one or more batteries of one or more external devices that are in communication with the computer system) on the surface (e.g., 600c and/or 600e) of the computer system that is separate from the first display generation component (e.g., 600a). Displaying charge state information on the surface of the computer system that is separate from the first display generation component provides improved feedback about a state of the computer system (e.g., a charge state of the battery of the computer system). In some embodiments, the computer system updates the charge state information over time as the battery charge state changes, the computer system starts charging the battery, and/or the computer system stops charging the battery.

In some embodiments, displaying information about the event includes displaying a calendar notification (e.g., 806 and/or 808) (e.g., a graphical indication of an event that is associated with a calendar application operating at the computer system) on the surface (e.g., 600c and/or 600e) of the computer system (e.g., 600) that is separate from the first display generation component (e.g., 600a). Displaying a calendar notification on the surface of the computer system that is separate from the first display generation component provides improved feedback about a state of the computer system (e.g., a state in which a calendar event is triggered). In some embodiments, the calendar notification includes information about the event such as, for example, a start time, event name, description information, location, duration, and/or one or more invitees.

In some embodiments, displaying information about the event includes displaying a digital pass (e.g., 870 and/or 1025) (e.g., a graphical representation of ticket information such as a boarding pass for boarding a plane, train, or other vehicle or for gaining entry to an event or location) on the surface (e.g., 600c and/or 600e) of the computer system (e.g., 600) that is separate from the first display generation component (e.g., 600a). Displaying a digital pass on the surface of the computer system that is separate from the first display generation component provides improved feedback about a state of the computer system (e.g., a state in which the digital pass is presented for use) and provides for convenient use of the digital pass (e.g., while the computer system is being used for a different purpose). In some embodiments, the digital pass includes a QR code or other machine-readable code or data that can be scanned to gain entry to the event. In some embodiments, the digital pass alternatively includes information indicating that the computer system will provide the information (e.g., a QR code or other machine-readable code or data for gaining entry to the event) when in proximity to a wireless reader such as an NFC reader (e.g., for an NFC pass).

In some embodiments, the digital pass (e.g., 870 and/or 1025) is displayed on the surface (e.g., 600c and/or 600e) of the computer system (e.g., 600) that is separate from the first display generation component (e.g., 600a) while the computer system is being used for a purpose that is unrelated to (e.g., separate and distinct from) use of the digital pass (e.g., the first display generation component is displaying content that is not associated with the digital pass). For example, the computer system is being used (e.g., via the first display generation component) to browse the Internet or view and/or compose a message such as an email or text message while the computer system is displaying the digital pass on the surface of the computer system that is separate from the first display generation component. Displaying the digital pass on the surface of the computer system that is separate from the first display generation component while the computer system is being used for a purpose that is unrelated to use of the digital pass provides for convenient use of the digital pass while a primary display generation component of the computer system is in use for a different purpose.

In some embodiments, displaying information about the event includes displaying order status information (e.g., 1006) (e.g., a graphical representation of information associated with a purchase order for a product, good, and/or service such as processing information, shipping information, tracking information, delivery information, and/or return information) on the surface (e.g., 600c and/or 600e) of the computer system (e.g., 600) that is separate from the first display generation component (e.g., 600a). Displaying order status information on the surface of the computer system that is separate from the first display generation component provides improved feedback about a state of the computer system and provides for convenient access to the order status information (e.g., while the computer system is being used for a different purpose). In some embodiments, the computer system updates the order status information over time (e.g., as the status of the order changes). For example, in FIG. 6E, notification 1006 has been updated to indicate the food order has been delivered.

Note that details of the processes described above with respect to method 1100 (e.g., FIG. 7) are also applicable in an analogous manner to the methods described above and below. For example, method 700, method 900, and/or method 1300 optionally includes one or more of the characteristics of the various methods described above with reference to method 1100. For example, information displayed using the rear-display can be positioned or arranged based on an orientation of the computer system and/or a detected obstruction of a portion of the rear display. For brevity, these details are not repeated.

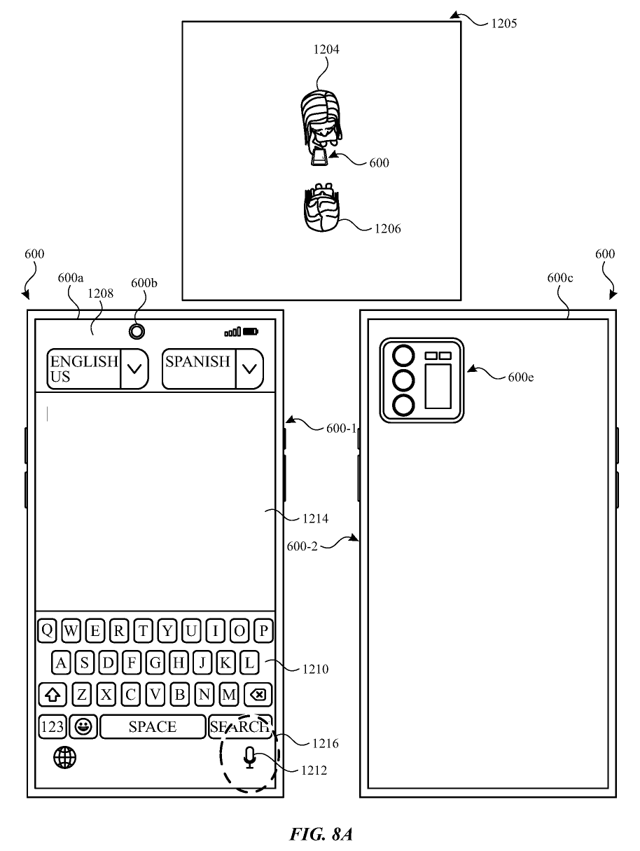

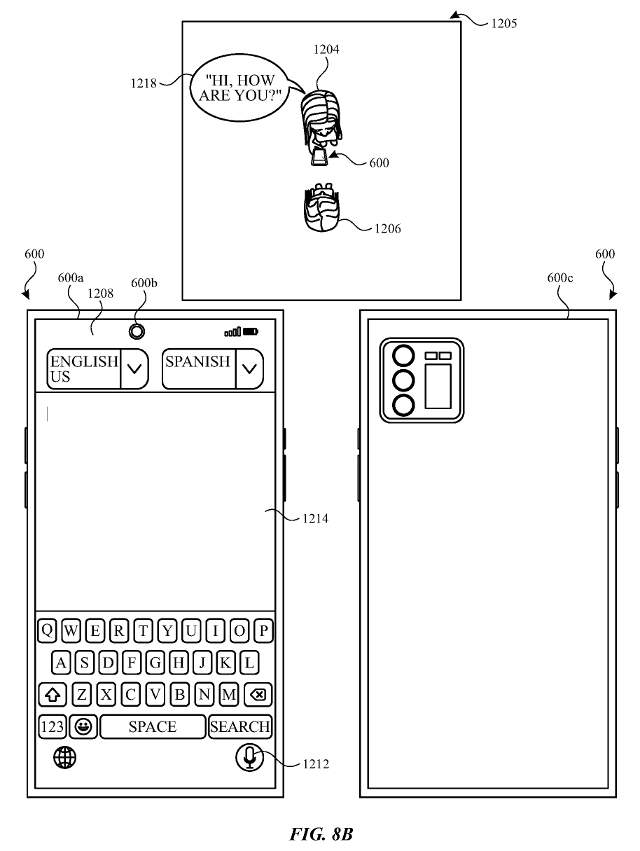

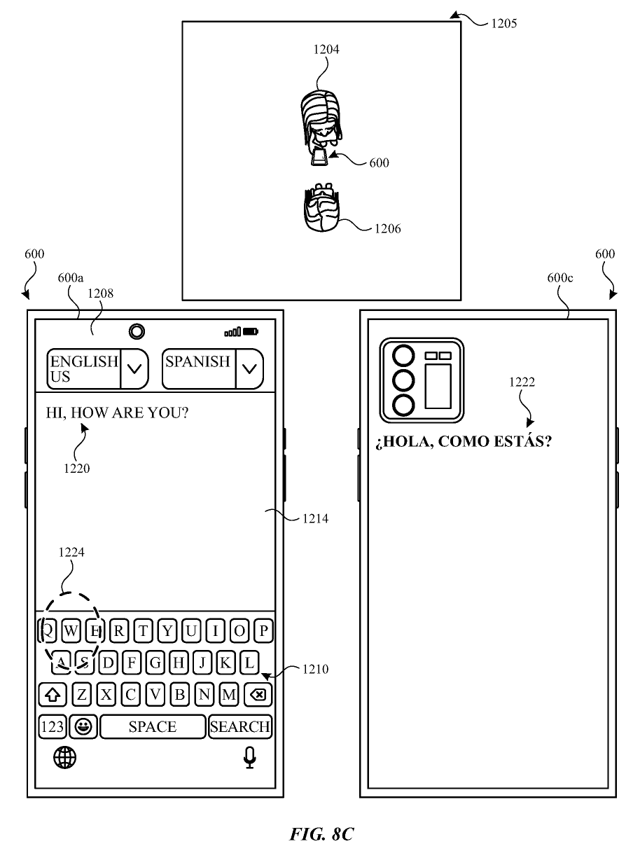

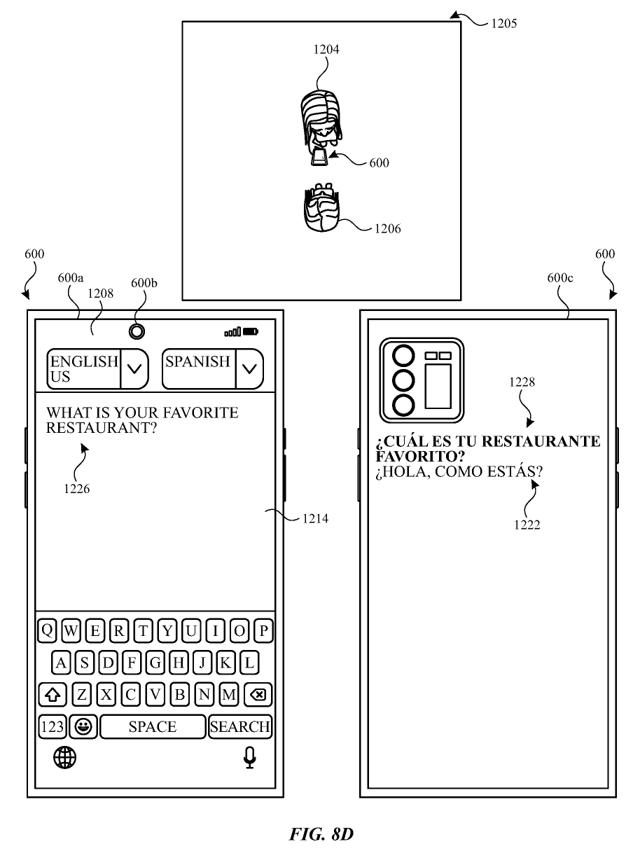

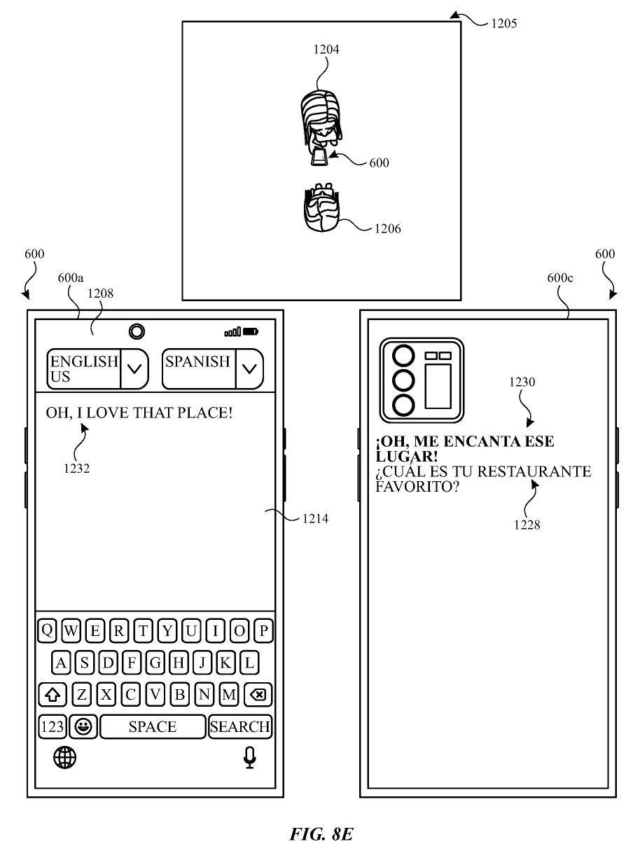

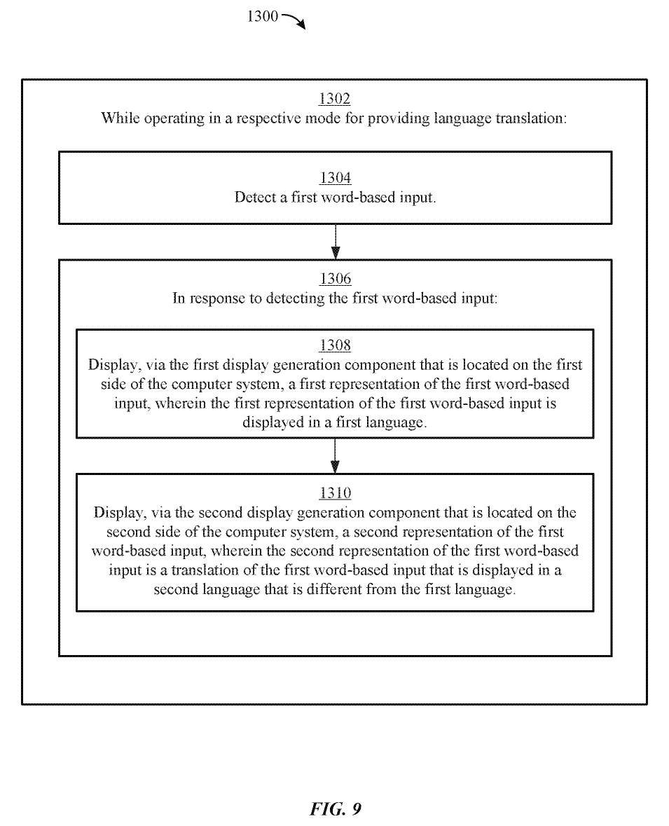

FIGS. 8A-8E illustrate exemplary user interfaces for providing language translation using a rear-side display, in accordance with some embodiments. The user interfaces in these figures are used to illustrate the processes described below, including the processes in FIG. 9.

FIGS. 8A-8E depict an embodiment in which computer system 600 is operating in a language translation mode (e.g., by using a translation application operating at the computer system) to provide English-to-Spanish language translation between users Jane 1202 and Juanita 1204 depicted in schematic 1205. Specifically, Jane is using computer system 600 to translate English, word-based input (e.g., typed or spoken words) into Spanish, word-based output for Juanita. It should be appreciated that the embodiment depicted in FIGS. 8A-8E is one example of language translation provided using computer system 600. Accordingly, the techniques described herein can be implemented using computer system 600 to provide language translation using different languages and/or scenarios than those described herein. For example, in FIGS. 8A-8E, Juanita does not use a separate device to communicate with Jane; however, in some embodiments, Juanita could use a separate device (e.g., same as or similar to computer system 600) to provide language translation for Juanita in a manner analogous to that described herein using computer system 600 such that the users have a translated conversation using their respective devices.

In FIG. 8A, computer system 600 displays translation interface 1208 which includes keyboard 1210, microphone affordance 1212, and text input region 1214. In FIG. 8A, no word-based input has been received by computer system 600 in the language translation mode and, thus, the computer system has not provided any translation output using display 600a or rear display 600c. Computer system 600 detects input 1216 (e.g., a touch input and/or air gesture) selecting microphone affordance 1212 and, in response, activates microphone 600j to receive spoken input for translation as depicted in FIG. 8B.

In FIG. 8B, Jane says “Hi, how are you?” in English, which is detected as spoken input 1218 using microphone 600j of the computer system. When computer system 600 determines that Jane has finished speaking, the computer system displays English text 1220 of the spoken input using display 600a, translates the spoken English input into Spanish, and displays translated Spanish output 1222 using rear display 600c, as depicted in FIG. 8C. Because display 600a faces the user (Jane) who is speaking the language to be translated, computer system 600 displays the English input using display 600a, thereby providing feedback to Jane so that she can confirm that the English input was accurately detected by the computer system. In some embodiments, computer system 600 also displays the translated Spanish output using display 600a. Computer system 600 displays the translated Spanish output 1222 using rear display 600c, because rear display 600c faces the user (Juanita) who is receiving the translated output. In some embodiments, the computer system waits to translate the word-based input until after the computer system has determined that the user is finished providing the input (e.g., after a predetermined amount of time has passed since microphone affordance 1212 was selected or after a predetermined amount of time has passed since any last detected input (e.g., spoken or typed)). This enables the computer system to provide a more accurate and/or complete translation of the word-based input because the entire input is received before performing the translation. However, in some embodiments, the computer system translates (and, optionally, outputs the translation) in real time as the word-based input is received, which can provide quicker translation.

In FIG. 8C, computer system 600 detects input 1224 (e.g., one or more touch inputs or a touch input gesture) selecting keys of keyboard 1210 to provide a typed, word-based input in English, as shown in FIG. 8D. Computer system 600 updates text input region 1214 by replacing English text 1220 (“Hi, how are you?”) with new English text 1226 (“What is your favorite restaurant?”) representing the typed, word-based input provided using input 1224. Alternatively, in some embodiments, new English text 1226 is added to text input region 1214 so that the user can see the new English input with the previous English input. Computer system 600 translates the new English input (e.g., English text 1226) and displays translated Spanish output 1228 using rear display 600c. In some embodiments, computer system 600 deemphasizes previous translated output text relative to new translated output text so that a user can quickly distinguish new translated output from previous translated output. For example, in FIG. 8D, computer system 600 moves translated Spanish output 1222 to a different (e.g., lower or higher) location on rear display 600c and displays translated Spanish output 1228 at the location where translated Spanish output 1222 was previously displayed. Furthermore, the font thickness of Spanish output 1222 is decreased so that Spanish output 1228 is displayed with a bolded appearance relative to Spanish output 1222. In some embodiments, computer system 600 scrolls the previous translated output (e.g., translated Spanish output 1222) to make room for the new translated output (e.g., translated Spanish output 1228).

In some embodiments, as new translated output is displayed on display 600c, computer system 600 scrolls previously translated (e.g., stale) output offscreen to make room for the new translated output. For example, in FIG. 8E, translated Spanish output 1228 is scrolled down on display 600c, and translated Spanish output 1222 has been scrolled offscreen, so that new translated Spanish output 1230 is displayed with an emphasized appearance. New translated Spanish output 1230 is a Spanish translation of an English word-based input (e.g., spoken or typed) represented by English text 1232 (“Oh, I love that place!”).

FIG. 9 is a flow diagram illustrating a method for providing language translation using a rear-side display of a computer system in accordance with some embodiments. Method 1300 is performed at a computer system (e.g., 100 and/or 600) (e.g., a smartphone, a wearable device (e.g., a smartwatch), a tablet computer, a desktop computer, a laptop computer, and/or a head-mounted device (e.g., a head-mounted augmented reality and/or extended reality device)) that is in communication with (e.g., includes and/or is connected to) one or more input devices (e.g., 600a and/or 600j) (e.g., a microphone, a touch-sensitive surface, a keyboard, mouse, trackpad, one or more optical sensors for detecting gestures, one or more capacitive sensors for detecting hover inputs, and/or accelerometer/gyroscope/inertial measurement units) and two or more display generation components including a first display generation component (e.g., 600a) (e.g., a high-fidelity display, a primary display, a main display, a display controller, a touch-sensitive display system, a display screen, a monitor, a projector, a holographic display, and/or a head-mounted display system) that is located on a first side (e.g., 600-1) of the computer system (e.g., a side of the computer system that primarily faces the user of the computer system when the computer system is being used by the user (e.g., a front side, a front-facing side, and/or a user-facing side of the computer system)) and a second display generation component (e.g., 600c) (e.g., a low-fidelity display, a secondary display, an auxiliary display, a display controller, a touch-sensitive display system, a display screen, a monitor, a projector, a holographic display, and/or a head-mounted display system) that is different from the first display generation component and is located on a second side (e.g., 600-2) of the computer system (e.g., a side of the computer system that primarily faces away from the user of the computer system when the computer system is being used by the user (e.g., a back side, rear-facing side, and/or outward-facing side of the computer system)) that is different from (e.g., opposite and/or juxtaposed) the first side of the computer system. In some embodiments, the second display generation component is configured to display content at a lower fidelity (e.g., a lower fidelity, lower definition, lower resolution, smaller range of colors, lower range of greyscale, and/or lower contrast ratio) than the first display generation component (e.g., the first display generation component is configured to display content at a greater fidelity, higher definition, higher resolution, greater range of colors, greater range of greyscale, and/or greater contrast ratio than the second display generation component). In some embodiments, an input device is part of a display generation component (e.g., 600a). Some operations in method 1300 are, optionally, combined, the orders of some operations are, optionally, changed, and some operations are, optionally, omitted.

As described below, method 1300 provides an intuitive way for providing language translation using a rear-side display of a computer system. The method reduces the cognitive burden on a user for operating the computer system using the rear-side display, thereby creating a more efficient human-machine interface. For battery-operated computing devices, enabling a user to use a rear-side display to interface with the computer system faster and more efficiently conserves power and increases the time between battery charges.

In method 1300, while the computer system (e.g., 600) is operating (1302) in a respective mode for providing language translation (e.g., translating text from a first language to a second language that is different from the first language), the computer system performs the following steps.

The computer system (e.g., 600) detects (1304), via the one or more input devices (e.g., 600a and/or 600j) a first word-based input (e.g., 1218 and/or 1224) (e.g., one or more words and/or phrases input in a respective language) (e.g., typed entry of the word-based input detected using a touch-sensitive surface and/or spoken entry of the word-based input detected using a microphone). In some embodiments, the first word-based input is provided in the first language.

In response (1306) to detecting the first word-based input (e.g., 1218 and/or 1224), the computer system (e.g., 600) displays (1308), via the first display generation component (e.g., 600a) that is located on the first side (e.g., 600-1) of the computer system, a first representation (e.g., 1220, 1226, or 1232) of the first word-based input (e.g., a first textual representation of the first word-based input), wherein the first representation of the first word-based input is displayed in a first language (e.g., English, French, or another language). In some embodiments, the first representation of the first word-based input is displayed in a same language as the first word-based input. For example, the first word-based input and the first representation of the first word-based input are both in English language. The computer system also displays (1310), via the second display generation component (e.g., 600c) that is located on the second side (e.g., 600-2) of the computer system, a second representation (e.g., 1222, 1228, or 1230) of the first word-based input (e.g., a second textual representation of the first word-based input), wherein the second representation of the first word-based input is a translation of the first word-based input that displayed in a second language that is different from the first language (e.g., a Spanish translation of the first word-based input or a German translation of the first word-based input). Displaying the first representation of the first word-based input in a first language using the first display generation component that is located on the first side of the computer system, and displaying the second representation of the first word-based input that is a translation of the first word-based input that is displayed in a second language using the second display generation component that is located on the second side of the computer system, provides additional control options for translating word-based inputs without cluttering the user interface with additional displayed controls while allowing for two parties to communicate in two different languages without having to share a single user interface for communicating. In some embodiments, the translation is generated by the computer system. In some embodiments, the translation is generated by a server or remote computer system that is in communication with the computer system.

In some embodiments, the first word-based input is a text input (e.g., 1224) (e.g., an input provided via typing on a keyboard and/or providing a gesture to enter text). In some embodiments, the first word-based input is an audio input (e.g., 1218) (e.g., an input provided via voice or other spoken input).

In some embodiments, the computer system (e.g., 600) displays the first representation (e.g., 1220, 1226, or 1232) of the first word-based input via the first display generation component (e.g., 600a) that is located on the first side (e.g., 600-1) of the computer system without displaying the first representation of the first word-based input via the second display generation component (e.g., 600c) that is located on the second side (e.g., 600-2) of the computer system (e.g., the entered word-based input is not displayed using the second display generation component that is located on the second side of the computer system). Displaying the first representation of the first word-based input via the first display generation component that is located on the first side of the computer system without displaying the first representation of the first word-based input via the second display generation component that is located on the second side of the computer system conserves computational resources and provides improved feedback by providing the translation of the word-based input without cluttering the user interface with the additional display of the non-translated representation of the word-based input. In some embodiments, in response to detecting the first word-based input, the computer system forgoes displaying the first representation of the first word-based input via the second display generation component that is located on the second side of the computer system.

In some embodiments, the computer system (e.g., 600) displays the second representation (e.g., 1222, 1228, or 1230) of the first word-based input via the second display generation component (e.g., 600c) that is located on the second side (e.g., 600-2) of the computer system without displaying the second representation of the first word-based input via the first display generation component (e.g., 600a) that is located on the first side (e.g., 600-1) of the computer system (e.g., the translation of the word-based input is not displayed using the first display generation component that is located on the first side of the computer system). Displaying the second representation of the first word-based input via the second display generation component that is located on the second side of the computer system without displaying the second representation of the first word-based input via the first display generation component that is located on the first side of the computer system conserves computational resources and provides improved feedback by providing the first representation of the word-based input without cluttering the user interface with the additional display of the translated representation of the word-based input. In some embodiments, in response to detecting the first word-based input, the computer system forgoes displaying the second representation of the first word-based input via the first display generation component that is located on the first side of the computer system.

In some embodiments, in response to detecting the first word-based input (e.g., 1218 and/or 1224), the computer system (e.g., 600) displays, via the first display generation component (e.g., 600a) that is located on the first side (e.g., 600-1) of the computer system, the second representation (e.g., 1222, 1228, or 1230) of the first word-based input (e.g., both the word-based input and the translation of the word-based input are displayed using the first display generation component that is located on the first side of the computer system). Displaying the second representation of the first word-based input via the first display generation component that is located on the first side of the computer system provides improved feedback by providing both the first representation of the word-based input and the corresponding translation without requiring the user to physically manipulate the computer system to view the second translation provided on the second side of the computer system.

In some embodiments, the computer system (e.g., 600) detects, via the one or more input devices (e.g., 600a and/or 600j), a second word-based input (e.g., 1224) (e.g., a subsequent word-based input (e.g., in the first language) that is detected after detecting the first word-based input). In response to detecting the second word-based input, the computer system displays, via the second display generation component (e.g., 600c) that is located on the second side (e.g., 600-2) of the computer system, a representation (e.g., 1228 or 1230) of the second word-based input, wherein the representation of the second word-based input is a translation of the second word-based input that is displayed in the second language (e.g., when a new word-based input is detected, the translation of the new word-based input is displayed (e.g., automatically or in response to additional input) on the second side of the computer system). Displaying the representation of the second word-based input via the second display generation component in response to detecting the second word-based input provides improved feedback and reduces the number of inputs needed to provide translation of the word-based input by automatically updating the displayed translation of the word-based input to include a translation of the latest word-based input without requiring further user input. In some embodiments, in response to detecting the second word-based input the computer system displays, via the first display generation component (e.g., 600a) that is located on the first side (e.g., 600-1) of the computer system, a representation (e.g., 1220 or 1232) of the second word-based input that is displayed in the first language.

In some embodiments, displaying the representation (e.g., 1228) of the second word-based input (e.g., 1224) includes concurrently displaying the representation of the second word-based input with the second representation (e.g., 1222) of the first word-based input (e.g., 1218) using the second display generation component (e.g., 600c) that is located on the second side (e.g., 600-2) of the computer system (e.g., 600) (e.g., the newly translated text is displayed concurrently with the previously translated text). Concurrently displaying the representation of the second word-based input with the second representation of the first word-based input using the second display generation component that is located on the second side of the computer system provides improved feedback by displaying a translated transcript of recent word-based input. In some embodiments, the computer system deemphasizes earlier translated text when new translated text is displayed. For example, when the representation of the second word-based input is concurrently displayed with the second representation of the first word-based input, the computer system displays the second representation of the first word-based input with an appearance that is deemphasized (e.g., faded, relocated to a less prominent location on the display, resized, or otherwise deemphasized) relative to an appearance of the displayed representation of the second word-based input (e.g., as shown in FIG. 8D or FIG. 8E). In some embodiments, concurrently displaying the representation (e.g., 1228) of the second word-based input (e.g., 1224) with the second representation (e.g., 1222) of the first word-based input (e.g., 1218) includes scrolling the second representation of the first word-based input from a first location on the second display generation component (e.g., 600c) that is located on the second side (e.g., 600-2) of the computer system (e.g., 600) to a second location on the second display generation component that is different from the first location and displaying the representation of the second word-based input at the first location. Scrolling the second representation of the first word-based input from the first location on the second display generation component that is located on the second side of the computer system to the second location on the second display generation component and displaying the representation of the second word-based input at the first location provides improved feedback about a state of the device (e.g., indicating a state in which new translated text is being displayed). In some embodiments, the computer system scrolls the earlier translated text to make room for the new translated text on the second display generation component.

In some embodiments, in response to detecting the second word-based input (e.g., 1224), the computer system (e.g., 600) ceases displaying the second representation (e.g., 1222) of the first word-based input (e.g., 1218) using the second display generation component (e.g., 600c) that is located on the second side (e.g., 600-2) of the computer system. Ceasing display of the second representation of the first word-based input while displaying the representation of the second word-based input using the second display generation component that is located on the second side of the computer system conserves computational resources and provides improved feedback by displaying the representation of the second word-based input without cluttering the user interface with the additional display of the second representation of the first word-based input. In some embodiments, the computer system ceases display of the earlier translated text when the new translated text is displayed using the second display generation component that is located on the second side of the computer system. In some embodiments, ceasing display of the second representation of the first word-based input includes displaying a visual animation in which the second representation of the first word-based input moves out of view (e.g., by scrolling or sliding out of view). Displaying a visual animation in which the second representation of the first word-based input moves out of view provides improved feedback about a state of the computer system (e.g., indicating a state in which previously translated text is being replaced with newly translated text).

Note that details of the processes described above with respect to method 1300 (e.g., FIG. 9) are also applicable in an analogous manner to the methods described above. For example, method 700, method 900, and/or method 1100 optionally includes one or more of the characteristics of the various methods described above with reference to method 1300. For example, a recording indicator can be displayed using the rear-side display in accordance with the embodiments described with respect to method 700. As another example, the content displayed as described in connection with methods 900, 1100, and 1300 can, in some embodiments, be displayed using a removable case for the computer system, as described with respect to method 700. For brevity, these details are not repeated.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

To the extent that the methods, computer programs, and devices described above result in the collection, analysis, disclosure, transfer, storage, or other use of any personal information, those methods, computer programs, and devices will be configured to comply with well-established privacy policies and/or privacy practices.

Although the disclosure and embodiments have been fully described with reference to the accompanying drawings, it is to be noted that various changes and modifications will become apparent to those skilled in the art. Such changes and modifications are to be understood as being included within the scope of the disclosure and embodiments as defined by the claims.

What is claimed is:

1. A computer system that is configured to communicate with one or more cameras and two or more display generation components, including a first display generation component that is located on a first side of the computer system and a second display generation component that is different from the first display generation component and is located on a second side of the computer system that is different from the first side of the computer system, wherein the second display generation component is configured to display content at a lower fidelity than the first display generation component, comprising:
one or more processors; and
memory storing one or more programs configured to be executed by the one or more processors, the one or more programs including instructions for:
capturing data using the one or more cameras;
while capturing data using the one or more cameras, displaying, via the second display generation component, camera status information that indicates a status for the one or more cameras; and
while capturing data using the one or more cameras and while the camera status information is displayed via the second display generation component, displaying, via the first display generation component, respective content, wherein the respective content is displayed at a higher fidelity than the camera status information.

2. The computer system of claim 1, wherein displaying the camera status information that indicates a status for the one or more cameras includes updating an appearance of the camera status information over time.

3. The computer system of claim 2, wherein updating the appearance of the camera status information over time includes displaying an animation of the camera status information changing from a first appearance to a second appearance that is different from the first appearance.

4. The computer system of claim 2, wherein updating the appearance of the camera status information over time includes displaying movement of one or more user interface elements that are displayed via the second display generation component.

5. The computer system of claim 1, wherein the camera status information indicates respective locations of one or more faces detected in a field of view of the one or more cameras.

6. The computer system of claim 1, wherein displaying the camera status information includes:
displaying, via the second display generation component, a graphical representation of a field of view of the one or more cameras; and
displaying, via the second display generation component, one or more graphical representations of a face detected in the field of view of the one or more cameras, wherein the one or more graphical representations of a face are displayed at a location relative to the displayed graphical representation of the field of view of the one or more cameras that corresponds to a location of a face detected in the field of view of the one or more cameras.

7. The computer system of claim 1, wherein displaying the camera status information includes:
displaying, via the second display generation component, a first graphical representation of a first face detected in a field of view of the one or more cameras; and
displaying, via the second display generation component, a second graphical representation of a second face detected in the field of view of the one or more cameras, wherein the first graphical representation of the first face is displayed at a location relative to the second graphical representation of the second face that corresponds to a location of the first face relative to the second face detected in the field of view of the one or more cameras.

8. The computer system of claim 1, wherein displaying the camera status information includes:
in accordance with a determination that a first set of criteria is met, wherein the first set of criteria is met when a respective face is detected having a position that is at least partially outside of a field of view of the one or more cameras, displaying a graphical element indicating that one or more faces are at least partially outside of the field of view of the one or more cameras; and
in accordance with a determination that the first set of criteria is not met, forgoing displaying the graphical element indicating that one or more faces are at least partially outside of the field of view of the one or more cameras.

9. The computer system of claim 1, wherein the computer system is in communication with a plurality of cameras lenses corresponding to the one or more cameras, and wherein displaying the camera status information includes:
in accordance with a determination that one or more of the plurality of camera lenses is in an active state, displaying, via the second display generation component, an indication that the one or more of the plurality of camera lenses is in the active state; and
in accordance with a determination that the one or more of the plurality of cameras lenses is not in the active state, forgoing displaying the indication that the one or more of the plurality of camera lenses is in the active state.

10. The computer system of claim 1, wherein displaying the camera status information includes:
in accordance with a determination that the computer system is in a first recording state, displaying, via the second display generation component, a recording status indicator; and
in accordance with a determination that the computer system is not in the first recording state, forgoing displaying the recording status indicator.

11. The computer system of claim 1, wherein the camera status information includes an indication of a location of a capture input region.

12. The computer system of claim 1, wherein:
the one or more cameras includes a first set of one or more cameras that is located on the first side of the computer system and a second set of one or more cameras that is located on the second side of the computer system; and
the second set of one or more cameras have a set of characteristics that is greater than a set of characteristics of the first set of one or more cameras.

13. The computer system of claim 1, wherein the camera status information is displayed in accordance with a determination that the computer system is in a respective camera mode.

14. The computer system of claim 1, wherein the second display generation component is integrated into a structure that surrounds at least a portion of the computer system.

15. The computer system of claim 1, wherein the second display generation component is integrated into a housing of the computer system.

16. The computer system of claim 1, wherein the camera status information includes a representation of the data captured using the one or more cameras.

17. A non-transitory computer-readable storage medium storing one or more programs configured to be executed by one or more processors of a computer system that is in communication with one or more cameras and two or more display generation components, including a first display generation component that is located on a first side of the computer system and a second display generation component that is different from the first display generation component and is located on a second side of the computer system that is different from the first side of the computer system, wherein the second display generation component is configured to display content at a lower fidelity than the first display generation component, the one or more programs including instructions for:
capturing data using the one or more cameras;
while capturing data using the one or more cameras, displaying, via the second display generation component, camera status information that indicates a status for the one or more cameras; and
while capturing data using the one or more cameras and while the camera status information is displayed via the second display generation component, displaying, via the first display generation component, respective content, wherein the respective content is displayed at a higher fidelity than the camera status information.

18. A method, comprising:
at a computer system that is in communication with one or more cameras and two or more display generation components including a first display generation component that is located on a first side of the computer system and a second display generation component that is different from the first display generation component and is located on a second side of the computer system that is different from the first side of the computer system, wherein the second display generation component is configured to display content at a lower fidelity than the first display generation component:
capturing data using the one or more cameras;
while capturing data using the one or more cameras, displaying, via the second display generation component, camera status information that indicates a status for the one or more cameras; and
while capturing data using the one or more cameras and while the camera status information is displayed via the second display generation component, displaying, via the first display generation component, respective content, wherein the respective content is displayed at a higher fidelity than the camera status information.
